(19) United States
(12) Patent Application Publication
(10) Pub. No.: US 2025/0178951 A1
(43) Pub. Date: Jun. 5, 2025

(54) GLASS-CERAMIC AND CRYSTALLINE ARTICLES AND METHODS OF MAKING SAME

(71) Applicant: CORNING INCORPORATED, CORNING, NY (US)

(72) Inventors: Brian Daniel Fulmer, Westfield, PA (US); Timothy Michael Gross, Painted Post, NY (US)

(21) Appl. No.: 18/842,629

(22) PCT Filed: Mar. 6, 2023
(86) PCT No.: PCT/US2023/014561

§ 371 Date: Aug. 29, 2024

Related U.S. Application Data
(60) Provisional application No. 63/317,229, filed on Mar. 7, 2022.

(51) Int. Cl. C03C 10/00; C03C 3/085; C03C 4/00

(52) U.S. Cl. CPC C03C 10/0036; C03C 3/085; C03C 4/0028; C03C 4/0092

(57) ABSTRACT

Embodiments of the disclosure relate to glass-ceramic or crystalline article. The article includes 25 mol %≤silica≤60 mol %, 12.5 mol %≤alumina≤45 mol %, and 12.5 mol %≤strontium oxide≤45 mol %. According to certain embodiments, an interior of the article is mostly amorphous glass, and the interior is at least partially surrounded by a shell that is mostly crystalline. The shell defines a first major surface on a first side of the interior and a second major surface opposite to the first major surface on a second side of the interior. According to certain other embodiments, the article is a crystalline article in which columnar crystals grow inwardly from opposing surfaces and meet at about a midline of the article.

### CROSS-REFERENCE TO RELATED APPLICATIONS

This application claims the benefit of priority under 35 U.S.C. § 119 of U.S. Provisional Application No. 63/317,229 filed Mar. 7, 2022, the content of which is incorporated herein by reference in its entirety.

### BACKGROUND

Glass-ceramics are partially crystalline materials that can be formed by crystallizing a portion of amorphous glass. Crystallization can occur through some form of nucleation, such as homogeneous nucleation and heterogeneous nucleation. A part of a glass-ceramic that is not nucleated may be called an amorphous phase, whereas a nucleated portion of a glass-ceramic may be called a crystalline phase. The crystalline phase of a glass-ceramic can promote crack resistance. Glass-ceramics may be used for several applications, such as dishware, covers for electronic devices, or architectural products. Many glass-ceramic articles, and the methods for forming said glass-ceramic articles, are not ideal for attaining transparency levels desired for some products and applications.

### SUMMARY

In an aspect, embodiments of the present disclosure relate to a glass-ceramic article. The glass-ceramic article includes 25 mol %≤silica≤60 mol %; 12.5 mol %≤alumina≤45 mol %; and 12.5 mol %≤strontium oxide≤45 mol %. An interior of the glass-ceramic article is mostly amorphous glass, and the interior is at least partially surrounded by a shell that is mostly crystalline. The shell defines a first major surface on a first side of the interior and a second major surface opposite to the first major surface on a second side of the interior.

In one or more embodiments of the glass-ceramic article, the shell extends from one or both of the first major surface and the second major surface to a depth that is greater than or equal to 5 micrometers.

In one or more embodiments of the glass-ceramic article, the shell includes crystals, and most of the crystals are formed within 15 degrees of orthogonal to one or both of the first major surface and the second major surface of the glass-ceramic article.

In one or more embodiments of the glass-ceramic article, a volume of the shell is less than 50% of a volume of the glass-ceramic article.

In one or more embodiments of the glass-ceramic article, an absolute value of a difference between a first coefficient of thermal expansion of the interior and a second coefficient of thermal expansion of the shell is no more than 2 μm/(m° C.).

In one or more embodiments of the glass-ceramic article, the shell is made of crystals of Sr(Al₂Si₂O₈).

In one or more embodiments of the glass-ceramic article, alumina is present in an amount that is within 1 mol % of an amount of strontium oxide.

In one or more embodiments of the glass-ceramic article, the interior is at least 99% amorphous by volume, and the shell is at least 99% crystalline by volume. In one or more such embodiments of the glass-ceramic article, a transition between the shell and the interior is sudden such that the glass-ceramic article changes from at least 99% crystalline by volume to at least 99% amorphous by volume over a distance of less than 10 micrometers.

In one or more embodiments of the glass-ceramic article, the glass-ceramic article includes 1 mol % or less of other constituents individually and 5 mol % or less of all the other constituents in total.

In one or more embodiments of the glass-ceramic article, at least 80% of light having a wavelength in a range from 400 nm to 800 nm that is incident upon one of the first major surface or the second major surface the glass-ceramic article is transmitted axially through the glass-ceramic article to the other of the first major surface or the second major surface.

In another aspect, embodiments of the present disclosure relate to a glass-ceramic article. The glass-ceramic article includes a first crystalline shell extending to a first depth from a first major surface of the glass-ceramic article toward a centerline of the glass-ceramic article. A second crystalline shell extends to a second depth from a second major surface of the glass-ceramic article toward the centerline. The second major surface is opposite to the first major surface, and the centerline is halfway between the first major surface and the second major surface. An amorphous interior is disposed between the first crystalline shell and the second crystalline shell. The first and the second crystalline shells have a first coefficient of thermal expansion (CTE) and the amorphous interior comprises a second CTE. An absolute value of a difference between the first CTE and the second CTE is 2 μm/(m° C.).

In one or more embodiments of the glass-ceramic article, each of the first crystalline shell, the second crystalline shell, and the amorphous interior comprise a same composition. In one or more such embodiments, the composition includes silica, alumina, and strontium oxide. Further, in one or more such embodiments, the composition includes 25 mol %≤silica≤60 mol %; 12.5 mol %≤alumina≤45 mol %; and 12.5 mol %≤strontium oxide≤45 mol %.

In one or more embodiments of the glass-ceramic article, the first depth is from 5 micrometers to 250 micrometers and wherein the second depth is from 5 micrometers to 250 micrometers. In one or more such embodiments, the first depth is approximately equal to the second depth.

In one or more embodiments of the glass-ceramic article, each of the first crystalline shell and the second crystalline shell comprise columnar crystals extending from the first major surface and the second major surface, respectively. In one or more such embodiments, the columnar crystals are within 15 degrees of orthogonal to the first major surface and the second major surface, respectively.

In one or more embodiments of the glass-ceramic article, a transition between at least one of the first crystalline shell or the second crystalline shell and the amorphous interior is sudden such that the glass-ceramic article changes from at least 99% crystalline by volume in the first crystalline shell or the second crystalline shell to at least 99% amorphous by volume in the amorphous interior over a distance of less than 10 micrometers.

In one or more embodiments of the glass-ceramic article, at least 80% of light having a wavelength in a range from 400 nm to 800 nm that is incident upon one of the first major surface or the second major surface the glass-ceramic article is transmitted axially through the glass-ceramic article to the other of the first major surface or the second major surface.

In still another aspect, embodiments of the present disclosure relate to a method of manufacturing a glass-ceramic article. In the method, columnar crystals are nucleated at a surface of a glass article to form a crystalline shell around an amorphous interior. The columnar crystals extend to a depth of at least 5 micrometers into the glass-ceramic article.

In one or more embodiments of the method, nucleating involves heat treating the glass article at a temperature in a range from 1010° C. to 1080° C. In one or more such embodiments, heat treating is performed for a time of 1 hour to 5 hours. Further, in one or more such embodiments of the method, the surface is polished by abrading a portion of the crystalline shell after heat treating.

In one or more embodiments of the method, the depth of the crystalline shell is up to 250 micrometers.

In one or more embodiments of the method, prior to nucleating, the method further involves forming the glass article from a glass composition comprising 25 mol %≤silica≤60 mol %; 12.5 mol %≤alumina≤45 mol %; and 12.5 mol %≤strontium oxide≤45 mol %.

In one or more embodiments of the method, the crystalline shell has a first coefficient of thermal expansion (CTE), and the amorphous interior has a second CTE. An absolute value of a difference between the first CTE and the second CTE is 2 μm/(m° C.).

In one or more embodiments of the method, the columnar crystals are within 15 degrees of orthogonal to the surface.

In one or more embodiments of the method, a transition between the crystalline shell and the amorphous interior is sudden such that the glass-ceramic article changes from at least 99% crystalline by volume in the crystalline shell to at least 99% amorphous by volume in the amorphous interior over a distance of less than 10 micrometers.

According to another aspect, embodiments of the disclosure relate to a crystalline article. The crystalline article includes 40 mol %≤SiO₂≤50 mol %, 25 mol %≤Al₂O₃≤32.5 mol %, and 22.5 mol %≤SrO≤30 mol %. In one or more embodiments, Al₂O₃≥SrO. Further, in one or more embodiments, the crystalline article comprises at least 90 vol % crystalline material, and the crystalline material comprises 90 vol % of a single phase of crystal.

In one or more embodiments, the crystalline article includes a first major surface and a second major surface in which the second major surface is opposite to the first major surface. In one or more such embodiments, a distance between the first major surface and the second major surface defines a thickness of the crystalline article, and the thickness is at most 1 mm.

In one or more such embodiments, the crystalline article is made up of columnar crystals in which most of the columnar crystals are oriented within 15 degrees of normal to one or both of the first major surface and the second major surface of the crystalline article.

In one or more embodiments, the single phase of crystal is Sr(Al₂Si₂O₈). Further, in one or more embodiments, the crystalline phase includes 1 vol % or less of a second phase of crystal. In one or more such embodiments, the second phase is SrSiO₃.

In one or more embodiments of the crystalline article, the crystalline article transmits at least 70% of light having a wavelength of 400 nm to 800 nm.

In one or more embodiments of the crystalline article, the composition of the crystalline article includes 0<Al₂O₃—SrO≤5 mol %. In one or more embodiments of the crystalline article, the crystalline article includes 1 mol % or less of other constituents individually and 5 mol % or less of all the other constituents in total.

In one or more embodiments, the crystalline article includes a first crystalline region extending from the first major surface into the thickness and a second crystalline region extending from the second major surface into the thickness, and the first crystalline region meets the second crystalline region at about a midpoint of the thickness.

According to another aspect, embodiments of the disclosure relate to a crystalline article. The crystalline article includes 40 mol % to 50 mol % SiO₂ as well as Al₂O₃ and SrO. In the composition, Al₂O₃ and SrO are provided such that 0<Al₂O₃—SrO≤5 mol %. The crystalline article has a first major surface, a second major surface, and a thickness, and the second major surface is opposite to the first major surface. The thickness is a distance between the first major surface and the second major surface, and the thickness is 1 mm or less.

In one or more embodiments, the crystalline article includes SiO₂+Al₂O₃+SrO≥85 mol %. In one or more embodiments, the crystalline article is made up of at least 90 vol % of crystalline phase. In one or more such embodiments, the crystalline phase includes at least 90 vol % of a first crystal structure, which is in particular Sr(Al₂Si₂O₈). Further, in one or more such embodiments, the crystalline phase includes no more than 1 vol % of a second crystal structure, which is in particular SrSiO₃.

In one or more embodiments of the crystalline article, the crystalline article includes a first crystalline region and a second crystalline region. The first crystalline region includes columnar crystals extending from the first major surface toward a midpoint of the thickness, and the second crystalline region includes columnar crystals extending from the second major surface toward the midpoint of the thickness. In one or more such embodiments, the columnar crystals are oriented within 15° of normal to the respective first major surface and the second major surface.

In one or more embodiments, at least 70% of light having a wavelength in a range from 400 nm to 800 nm that is incident upon one of the first major surface or the second major surface of the crystalline article is transmitted through the crystalline article to the other of the first major surface or the second major surface.

According to still another aspect, embodiments of the disclosure relate to a method of manufacturing a crystalline article. In the method, first columnar crystals at a first major surface of a glass article and second columnar crystals at a second major surface of the glass article are nucleated until the first columnar crystals meet the second columnar crystals to form the crystalline article. The first columnar crystals and the second columnar crystals both extend inwardly from the respective first major surface and the second major surface. The glass article includes SiO₂, Al₂O₃, and SrO in which 40 mol %≤SiO₂≤50 mol % and 0≤Al₂O₃—SrO≤5 mol %.

In one or more embodiments of the method, the crystals are nucleated by heat treating the glass article at a temperature in a range from 1010° C. to 1080° C. In one or more such embodiments, the heat treating is performed for a time of 1 hour to 5 hours.

In one or more embodiments, at least one of the first major surface or the second major surface is polished by abrading a portion of at least one of the first major surface or the second major surface after heat treating.

In one or more embodiments of the method, the thickness is 1 mm or less.

In one or more embodiments of the method, the first columnar crystals and the second columnar crystals comprise at least 90 vol % of a first crystal structure, which is in particular Sr(Al₂Si₂O₈). Further, in one or more embodiments, the first columnar crystals and the second columnar crystals comprise 1 vol % or less of a second crystal structure, which is in particular SrSiO₃.

In one or more embodiments, the glass article includes 25 mol %≤Al₂O₃≤32.5 mol % and 22.5 mol %≤SrO≤30 mol %.

Additional aspects of the present innovation are described in the Detailed Description. From the detailed description, the drawings, and the claims, some aspects will be readily apparent to those skilled in the art as related to this disclosure. This Summary and the following Detailed Description are exemplary and build a framework to promote an understanding of a nature of the claims.

### BRIEF DESCRIPTION OF THE FIGURES

The Figures in this disclosure promote a further understanding of the claims. The Figures display one or more aspects of the innovative technology of the present disclosure. The Figures may be expounded upon further by additional specifications described in the Detailed Description.

FIG. 1A is a schematic side view of a glass-ceramic article, according to an embodiment of the present disclosure;

FIG. 1B is a digital image of a glass-ceramic article from a top-down perspective of the glass-ceramic article according to an aspect of innovations of the present disclosure.

FIG. 2 is a graph of thermal expansion of an amorphous glass-ceramic article according to an aspect of innovations of the present disclosure.

FIG. 3 is a graph of thermal expansion of a crystalline article according to an aspect of innovations of the present disclosure.

FIG. 4 is a graph of differential scanning calorimetry readings for a nucleated article as temperature changes according to an aspect of innovations of the present disclosure.

FIG. 5 is a digital image of a glass-ceramic article from a cross-sectional perspective of the glass, the glass being nucleated for 1 hour, 3 minutes at 1050° C., according to an aspect of innovations of the present disclosure.

FIG. 6 is a digital image of a glass-ceramic article from a cross-sectional perspective of the glass, the glass being nucleated for 2 hours, 33 minutes at 1050° C., according to an aspect of innovations of the present disclosure.

FIG. 7 is a digital image of a glass-ceramic article from a cross-sectional perspective of the glass, the glass being nucleated for 3 hours, 45 minutes at 1050° C., according to an aspect of innovations of the present disclosure.

FIG. 8 is a digital image of a glass-ceramic article from a cross-sectional perspective of the glass, the glass being nucleated for 4 hours, 36 minutes at 1050° C., according to an aspect of innovations of the present disclosure.

FIG. 9 is a digital image of a glass-ceramic article from a cross-sectional perspective of the glass, the glass having 130-micrometer shell thickness and 540-micrometer amorphous-interior thickness, according to an aspect of innovations of the present disclosure.

FIG. 10 is a graph of total transmittance vs. wavelength for a fully amorphous glass article, a glass-ceramic article, and a fully crystalline article according to an aspect of innovations of the present disclosure.

FIG. 11 is a graph of axial transmittance vs. wavelength for a fully amorphous glass article, a glass-ceramic article, and a fully crystalline article according to an aspect of innovations of the present disclosure.

FIG. 12 is a graph of diffuse transmittance vs. wavelength for a fully amorphous glass article, a glass-ceramic article, and a fully crystalline article according to an aspect of innovations of the present disclosure.

FIG. 13 is a graph of scatter ratio vs. wavelength for a fully amorphous glass article, a glass-ceramic article, and a fully crystalline article according to an aspect of innovations of the present disclosure.

FIG. 14 is a graph of X-Ray Diffraction Intensity vs. Two-Theta for a glass-ceramic article according to an aspect of innovations of the present disclosure.

FIG. 15 is a digital image of an indentation on a surface of a glass-ceramic article heat-treated for 4 hours, 36 minutes from a top-down perspective of the glass-ceramic article according to an aspect of innovations of the present disclosure.

FIG. 16 is a digital image of an indentation on a surface of a glass-ceramic article heat-treated for 2 hours, 30 minutes from a top-down perspective of the glass-ceramic article according to an aspect of innovations of the present disclosure.

FIG. 17 depicts stages of forming a crystalline article from an amorphous glass article, according to exemplary embodiments o the present disclosure.

FIGS. 18-21 depict SEM micrographs of crystalline articles having thicknesses of 0.53 mm, 1.00 mm, 1.03 mm, and 1.17 mm, respectively.

FIG. 22 depicts element dispersive spectroscopy scans of the crystalline phase of the crystalline article of FIG. 18.

FIG. 23 depicts element dispersive spectroscopy scans of the two distinct crystalline phases of the crystalline article FIG. 21.

FIG. 24 depicts an x-ray diffraction spectra for the single crystalline phase found in a sample having a thickness less than 1 mm.

FIG. 25 depicts an x-ray diffraction spectra for the two crystalline phases present in a sample having a thickness greater than 1 mm.

FIG. 26 is a graph of transmittance as a function of wavelength for crystalline articles at thicknesses of 0.40 mm, 0.87 mm, and 1.0 mm.

FIG. 27 is a graph of transmittance as a function of wavelength for crystalline articles having a single crystal phase with a thickness of 0.40 mm, a single crystal phase with a thickness of 1.0 mm, and multiple crystal phases with a thickness of 1.0 mm.

FIG. 28 depicts an SEM micrograph of a crack path produced by a Vickers indenter.

FIG. 29 depicts a crystalline article, demonstrating the transparency of the crystalline article, according to an embodiment of the present disclosure.

FIG. 30 depicts a micrograph of the crystal article of FIG. 29, demonstrating the columnar crystal structure, according to an exemplary embodiment of the present disclosure.

### DETAILED DESCRIPTION

The present disclosure is not limited to the aspects or methods described in this Detailed Description or shown by the Figures and/or described in relation to said Figures herein. As will be understood by those of ordinary skill in the art as related to this disclosure, aspects described in the Detailed Description and/or shown by the Figures may relate to one another or may apply to other aspects found elsewhere in the Detailed Description and/or the Figures.

There is a large demand for glass-ceramic and crystalline articles that are both highly transparent and highly durable. A current, common method of creating a glass-ceramic is forming the glass-ceramic via homogenous nucleation where nucleation occurs away from the surface of the system. Forming glass-ceramics via homogeneous nucleation, however, often achieves high transparency by limiting the percent crystallinity, because the orientation of the crystals in the shell of a homogeneously nucleated glass-ceramic is not ideal for transparency. Limiting percent crystallinity may result in very thin shells for the purpose of preventing high scattering of light, where high scattering of light would decrease transparency. However, a higher level of crystallinity is associated with a higher durability, and thus, from a durability standpoint, thicker crystalline shells are desirable. Thus, there exists a need for a material that may comprise a thicker crystalline shell or even be fully crystalline, while maintaining higher transparency and preventing against propagation of cracks.

As used herein, “most” and “mostly” mean greater than 50%. Further, attributes or characteristics that are “most” or “mostly” may be more narrowly quantified as at least 90%, such as at least 99% of the attributes or characteristics, such as crystallinity of a shell, amorphous-ness of an interior, and orientation(s) of shell crystals.

For the purposes of this disclosure, total transmittance is equal to diffuse transmittance added with axial transmittance. Moreover, for the purposes of this disclosure, “transmittance” in general refers to “total transmittance,” and, therefore, both “transmittance” and “total transmittance” refer to classically understood definitions (such as it is defined in ASTM International) of transmittance unless specified otherwise. Axial transmittance is the transmittance of light through a material where said light maintains its course through the material and to the detector's reader. Diffuse transmittance occurs when light deviates in different directions while passing through a material due to phenomena such as seeds, bubbles, or haze. Transmittance was measured for the glass-ceramic article by placing the article in a collection sphere detector. For the axial transmittance, the article was placed at a distance from the detector so that the light recorded passing through the material was the light maintaining its course through the material and to the detector, the detector recording little to no (ideally, zero) scattered light that passed through the material (as the scattered light will deviate away from the detector if the detector is placed far enough away from a material/sample). The diffuse transmittance was measured by removing a plug from the collection sphere so that the axial light (the light maintaining its course through the article) left the sphere and entered a light trap, so that the remaining light recorded in the sphere collector was diffuse light (the light that deviated course when passing through the article).

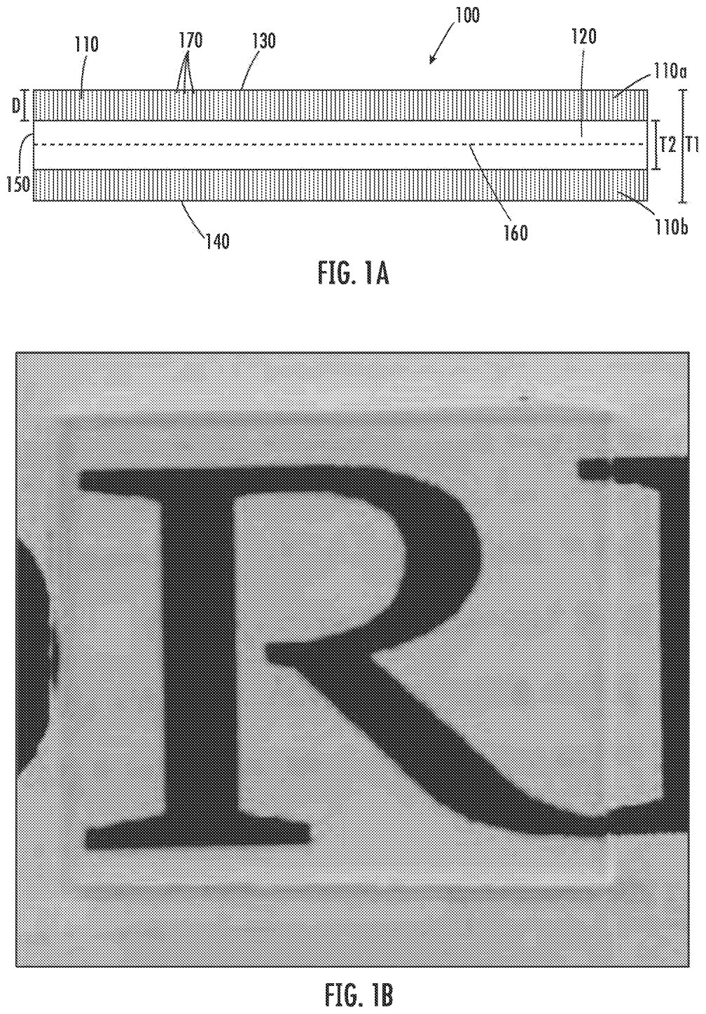

As depicted in FIG. 1A, a glass-ceramic article 100 in this disclosure comprises both a shell 110 and an amorphous interior 120. The amorphous interior 120 comprises mostly amorphous glass, and the shell 110 comprises mostly crystals. As used herein, the shell 110 and amorphous interior 120 may together be called a composite material.

The shell 110 may be considered a layer of columnar crystals, wherein the crystals adjoin one another to form the shell 110 and wherein individual crystals have a length and width orthogonal thereto. In aspects of this disclosure, individual crystals have a length of greater than or equal to twice a width of the crystal, such as a length greater than or equal to ten times the width, a length greater than or equal to twenty times the width, and a length greater than or equal to fifty times the width.

The shell 110 surrounds the amorphous interior 120 at least partially, or fully. In one or more embodiments, “surrounds” means that the shell 110 encloses the amorphous interior 120 and the amorphous interior 120 does not enclose the shell 110, and/or means that any curvature in the amorphous interior 120 includes that the shell 110 is formed around the curvature of the amorphous interior 120 and does not include that the amorphous interior 120 is formed around the shell 110, and/or means that the amorphous interior 120 is sandwiched between the shell 110 and that the shell 110 is not sandwiched between the amorphous interior 120. Including an amorphous interior 120 may have a substantial effect on the increasing transparency of the glass-ceramic article 100, where a combination of a shell 110 and an amorphous interior 120 can yield a glass-ceramic article 100 with higher total transmittance than a corresponding crystalline article in which the columnar crystals of the shell extend all the way to a center of the article such that there is no amorphous interior. Hence, when considering only a goal of increasing transparency for embodiments with at least some level of shell depth, it is more ideal to stop growth of columnar crystals before the crystals meet a center of the glass article. Notwithstanding and as will be discussed below, embodiments of the present disclosure also relate to fully crystalline articles.

The glass-ceramic article 100 includes a first major surface 130 and a second major surface 140 opposite to the first major surface 130. A minor surface 150 connects the first major surface 130 and the second major surface 130. The first major surface 130 and the second major surface 140 define a thickness T1 of the glass-ceramic article 100. For purposes of this disclosure, shell depth D refers to a distance of the shell 110 that extends from one of the first major surface 130 or the second major surface 140 of the glass-ceramic article 100 toward a centerline 160 of the glass-ceramic article 100. In general, the shell depth D will be less than half the thickness T1 of the glass-ceramic article 100. That is, in contrast to the fully crystalline embodiments discussed below, the columnar crystals extend from each of the first major surface 130 and the second major surface 140 without meeting at the centerline 160 of the glass-ceramic article 100. The thickness T2 of the amorphous interior 120 is the thickness T1 of the glass-ceramic article 100 less the depth D of each shell 110a, 110b, i.e., T2=T1−2D.

The shell 110 may be formed via heterogeneous nucleation, absent of nucleating agents. In other words, and more specifically, the shell 110 may be surface nucleated, e.g., from defects in the surface, to promote inward crystal growth which creates columnar crystals oriented normal, or near normal, to the respective surface 130, 140, 150. The normal, or near normal, orientation of the crystals in the shell creates relatively high transparency in the shell 110 and improves radial crack resistance as compared, e.g., to randomly oriented crystals. The amorphous interior may also have high transparency, due to the interior comprising mostly a glassy, amorphous composition.

The glass-ceramic article 100 may be formed to a range of sizes and shapes. In aspects of this disclosure, the glass-ceramic article 100 may be a rectangular article with the amorphous interior 120 at least partially sandwiched in between a top shell 110a and a bottom shell 110b. In aspects of this disclosure, the glass-ceramic article 100 may be a round article, such as a sphere or a spheroid, wherein the shell 110 at least partially surrounds the amorphous interior 120. In aspects of this disclosure, the glass-ceramic article 100 may have a combination of round and flat surfaces, such as a hemisphere, wherein the shell 110 at least partially surrounds the amorphous interior 120. In aspects of this disclosure, the glass-ceramic article 100 may be a sheet wherein the shell forms the major surfaces 130, 140 of the sheet as depicted in FIG. 1A. A sheet may have notable advantages, such as acting as a transparent cover for a device such as a cellular device. In aspects of the present disclosure, the thickness T1 of the glass-ceramic article 100 sheet may be greater than 10 micrometers, such as greater than 50 micrometers, or greater than 100 micrometers. Increasing the thickness of the sheet may increase the robustness of the sheet for applications that require a stronger and/or more durable transparent cover.

The shell 110 may be mostly crystalline, i.e., composed mostly of crystals. In aspects of this disclosure, the shell 110 may be at least 99% crystalline. In aspects of this disclosure, the shell 110 may be at least 90% crystalline. Higher crystallinity of the shell 110 and/or greater depth D of the shell 110 may result in lower transparency or transmittance. Higher crystallinity of the shell 110 and/or greater depth D of the shell 110 may result in higher robustness of the shell 110. In aspects of this disclosure, the amorphous interior 120 may be at least 99% amorphous by volume. In aspects of this disclosure, the amorphous interior 120 may be 90% amorphous by volume. Higher amorphousness of the amorphous interior 120 and/or greater thickness T2 of the amorphous interior 120 may result in greater transparency of the glass-ceramic article 100.

Desirably, crystals 170 of the shell grow normal to a surface (e.g., the first major surface 130 or the second major surface 140) of the shell 110 from which said crystals extend. The crystals 170 of the shell may not grow perfectly normal to a surface of the shell 110. Crystals 170 may grow almost perfectly, if not perfectly, normal to the surface of the shell 110. Crystals 170 may grow at a very slight angle away from a normal direction to the surface of the shell 110, such as 0.5 degrees from normal to a surface from which the crystals 170 extend. Other crystals 170 may grow at a significantly larger angle away from a normal direction to the surface of the shell 110, such as 15 degrees from normal to the surface from which the crystals 170 extend.

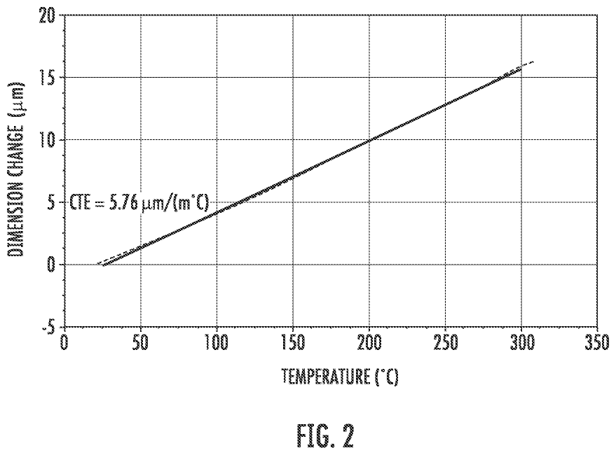

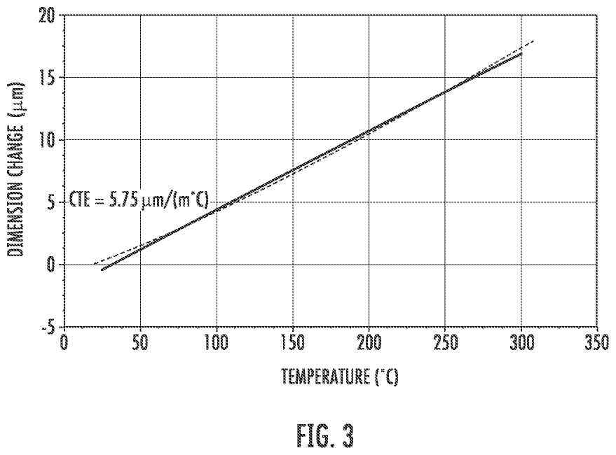

In one or more embodiments, the shell 110 and the amorphous interior 120 possess similar values for the coefficient of thermal expansion (CTE). Advantageously, close matching of the CTE values of the amorphous interior 120 and the shell 110 may help prevent cracking of the glass-ceramic article 100. In one or more embodiments, the smaller the mismatch between the CTE values of the amorphous interior 120 and the shell 110, the less likely the glass-ceramic article 100 will crack during manufacture. FIGS. 2 and 3 depict CTE values for an exemplary embodiment of an amorphous interior 120 and a crystalline shell 110, respectively, of a glass-ceramic article 100. As can be seen in FIG. 2, the CTE for the amorphous interior 120 is approximately 5.76 μm/(m° C.) between the temperatures of about 25° C. and about 300° C. As can be seen in FIG. 3, the CTE for the crystalline shell 110 is approximately 5.75 μm/(m° C.) between the same range of temperatures. For the crystalline shell 110, the CTE was measured in a direction parallel to a crystal growth direction (i.e., normal to a surface of the crystalline shell 110). Thus, in an exemplary embodiment, the CTE difference (absolute value) between the crystalline shell 110 and the amorphous interior 120 is only 0.01 μm/(m° C.). In one or more embodiments, the CTE difference (absolute value) between the crystal shell 110 and the amorphous interior 120 is 2 μm/(m° C.) or less, 1 μm/(m° C.) or less, 0.5 μm/(m° C.) or less, 0.2 μm/(m° C.) or less, 0.1 μm/(m° C.) or less, 0.05 μm/(m° C.) or less, 0.02 μm/(m° C.) or less, or 0.01 μm/(m° C.) or less. In one or more embodiments, the CTE values for the crystalline shell 110 and the amorphous interior 120 are the same (i.e., a difference of 0 μm/(m° C.)).

The glass-ceramic article 100 of this disclosure may have a thickness T1 of less than or equal to 5 mm, such as greater than or equal to 5 micrometers and less than or equal to 10 micrometers, greater than or equal to 5 micrometers and less than or equal to 50 micrometers, greater than or equal to 5 micrometers and less than or equal to 100 micrometers, greater than or equal to 5 micrometers and less than or equal to 500 micrometers, greater than or equal to 5 micrometers and less than or equal to 1 mm, greater than or equal to 5 micrometers and less than or equal to 5 mm, greater than or equal to 50 micrometers and less than or equal to 100 micrometers, greater than or equal to 50 micrometers and less than or equal to 500 micrometers, greater than or equal to 50 micrometers and less than or equal to 1 mm, greater than or equal to 50 micrometers and less than or equal to 5 mm, greater than or equal to 500 micrometers and less than or equal to 1 mm, greater than or equal to 500 micrometers and less than or equal to 5 mm, and any sub-ranges formed by any one of the foregoing starting points and/or endpoints provided herein.

Transparency may be measured by determining the transmittance of the glass, wherein transmittance is the fraction of incident light moving through a sample and is, thus, often measured as a percentage, and wherein greater transmittance equates to greater transparency and lower transmittance equates to lower transparency. Transmittance may depend on various factors, such as wavelengths of light passing through the glass-ceramic article or thickness of a glass-ceramic article. For instance, the higher the wavelength of the light passing through a glass-ceramic article, the greater the transmittance of the light will be when traveling through the article at said higher wavelength; and, for instance, the greater the thickness of a glass-ceramic article, the lower the transmittance for light will be when traveling through the article at said thickness. The Beer-Lambert Law describes that thickness is related to transmittance via the equation −log(T)=εlc, where T is transmittance through a sample, ε is the molar attenuation coefficient of species of the sample, c is the concentration of the species, and l is an optical path length or thickness of the sample. By the Beer-Lambert Law, it is apparent that transmittance of a sample such as a glass-ceramic article decreases as thickness of the glass-ceramic article increases, and transmittance of a sample such as a glass-ceramic article increases as thickness of the glass-ceramic article decreases. Thus, a low thickness for the glass-ceramic article, such as 5 micrometers, may lend to greater transparency. However, a high thickness for the glass-ceramic article, such as 1 mm, may lend to greater robustness and/or crack resistance. In one or more embodiments, the thickness T1 of the glass-ceramic article is no more than 5 mm in order to provide a balance between robustness and transparency. Notwithstanding, embodiments of the present disclosure extend to glass-ceramic articles with greater than 5 mm thickness and/or less than 50% light transmittance.

In aspects of this disclosure, the shell 110 may be fully crystalline or at least 99% crystalline, wherein crystal growth of the glass is oriented perpendicular from the surface and may extend to approximately half a thickness or volume of the glass-ceramic article 100. In aspects of this disclosure, the amorphous interior 120 may be fully amorphous or at least 99% amorphous, where there is little or no crystallization of the glass-ceramic article 100. In one or more embodiments, a transition between the shell 110 and the amorphous interior 120 is sudden such that the glass-ceramic article 100 changes from at least 99% crystalline by volume to at least 99% amorphous by volume over a distance of no more than 10 micrometers, no more than 5 micrometers, or no more than 1 micrometer. Such a sudden transition can be difficult to achieve without defects in the glass-ceramic article because of the tendency for certain conventional glass-ceramic articles to have large differences in CTE between the crystalline phase and the amorphous phase. Such conventional glass-ceramic articles having a sudden transition may be more susceptible to cracking and/or defects during nucleation. According to the present disclosure, a composition of the glass-ceramic article 100 was prepared to provide a glass-ceramic article 100 that was cable of providing a sudden transition between the crystalline shell 110 and amorphous interior 120. In particular, the presently disclosed composition is based on silica (SiO₂), alumina (Al₂O₃), and strontium oxide (SrO) in the ranges disclosed below.

In the present disclosure, silica, alumina, and strontium oxide (together, the “primary constituents”) may comprise a majority of constituents in the glass-ceramic article. In one or more embodiments, the primary constituents comprise at least 80 mol % of the glass-ceramic article 100, at least 85 mol % of the glass-ceramic article 100, at least 90 mol % of the glass-ceramic article 100, at least 95 mol % of the glass-ceramic article 100, or up to 100 mol % of the glass-ceramic article 100. In one or more embodiments, the glass-ceramic article 100 comprises the primary constituents in an amount in a range of 80 mol % to 100 mol %, 80 mol % to 95 mol %, 80 mol % to 90 mol %, 80 mol % to 85 mol %, 85 mol % to 100 mol %, 85 mol % to 95 mol %, 85 mol % to 90 mol %, 90 mol % to 100 mol %, 90 mol % to 95 mol %, 95 mol % to 100 mol %, or any ranges or subranges between the foregoing endpoints.

In one or more embodiments, the glass-ceramic article 100 may comprise silica (SiO₂) in an amount in the range of 25 mol %≤silica≤60 mol %, 25 mol %≤silica≤55 mol %, 25 mol %≤silica≤50 mol %, 25 mol %≤silica≤45 mol %, 25 mol %≤silica≤40 mol %, 25 mol %≤silica≤35 mol %, 25 mol %≤silica≤30 mol %, 30 mol %≤silica≤60 mol %, 30 mol %≤silica≤55 mol %, 30 mol %≤silica≤50 mol %, 30 mol %≤silica≤50 mol %, 30 mol %≤silica≤45 mol %, 30 mol %≤silica≤40 mol %, 30 mol %≤silica≤35 mol %, 35 mol %≤silica≤60 mol %, 35 mol %≤silica≤55 mol %, 35 mol %≤silica≤50 mol %, 35 mol %≤silica≤45 mol %, 35 mol %≤silica≤40 mol %, 40 mol %≤silica≤60 mol %, 40 mol %≤silica≤55 mol %, 40 mol %≤silica≤50 mol %, 40 mol %≤silica≤45 mol %, 45 mol %≤silica≤60 mol %, 45 mol %≤silica≤55 mol %, 45 mol %≤silica≤50 mol %, 50 mol %≤silica≤60 mol %, 50 mol %≤silica≤55 mol %, 55 mol %≤silica≤60 mol %, and any ranges or sub-ranges formed by any one of the foregoing starting points and/or endpoints provided herein.

In aspects of this disclosure, the glass-ceramic article may comprise alumina (Al₂O₃) in the range of 12.5 mol %≤alumina≤45 mol %, such as 12.5 mol %≤alumina≤40 mol %, 12.5 mol %≤alumina≤35 mol %, 12.5 mol %≤alumina≤30 mol %, 12.5 mol %≤alumina≤25 mol %, 12.5 mol %≤alumina≤20 mol %, 12.5 mol %≤alumina≤15 mol %, 17.5 mol %≤alumina≤45 mol %, 17.5 mol %≤alumina≤40 mol %, 17.5 mol %≤alumina≤35 mol %, 17.5 mol %≤alumina≤30 mol %, 17.5 mol %≤alumina≤30 mol %, 17.5 mol %≤alumina≤25 mol %, 17.5 mol %≤alumina≤20 mol %, 22.5 mol %≤alumina≤45 mol %, 22.5 mol %≤alumina≤40 mol %, 22.5 mol %≤alumina≤35 mol %, 22.5 mol %≤alumina≤30 mol %, 22.5 mol %≤alumina≤25 mol %, 27.5 mol %≤alumina≤45 mol %, 27.5 mol %≤alumina≤40 mol %, 27.5 mol %≤alumina≤35 mol %, 27.5 mol %≤alumina≤30 mol %, 32.5 mol %≤alumina≤45 mol %, 32.5 mol %≤alumina≤40 mol %, 32.5 mol %≤alumina≤35 mol %, 37.5 mol %≤alumina≤45 mol %, 37.5 mol %≤alumina≤40 mol %, 42.5 mol %≤alumina≤45 mol %, or any ranges and sub-ranges formed by any one of the foregoing starting points and/or endpoints provided herein.

In aspects of this disclosure, the glass-ceramic article may comprise strontium oxide (SrO) in the range of 12.5 mol %≤strontium oxide≤45 mol %, such as 12.5 mol %≤strontium oxide≤40 mol %, 12.5 mol %≤strontium oxide≤35 mol %, 12.5 mol %≤strontium oxide≤30 mol %, 12.5 mol %<strontium oxide≤25 mol %, 12.5 mol %≤strontium oxide≤20 mol %, 12.5 mol %≤strontium oxide≤15 mol %, 17.5 mol %≤strontium oxide≤45 mol %, 17.5 mol %≤strontium oxide≤40 mol %, 17.5 mol %≤strontium oxide≤35 mol %, 17.5 mol %≤strontium oxide≤30 mol %, 17.5 mol %≤strontium oxide≤30 mol %, 17.5 mol %≤strontium oxide≤25 mol %, 17.5 mol %≤strontium oxide≤20 mol %, 22.5 mol %≤strontium oxide≤45 mol %, 22.5 mol %≤strontium oxide≤40 mol %, 22.5 mol %≤strontium oxide≤35 mol %, 22.5 mol %≤strontium oxide≤30 mol %, 22.5 mol %≤strontium oxide≤25 mol %, 27.5 mol %≤strontium oxide≤45 mol %, 27.5 mol %≤strontium oxide≤40 mol %, 27.5 mol %≤strontium oxide≤35 mol %, 27.5 mol %≤strontium oxide≤30 mol %, 32.5 mol %≤strontium oxide≤45 mol %, 32.5 mol %≤strontium oxide≤40 mol %, 32.5 mol %≤strontium oxide≤35 mol %, 37.5 mol %≤strontium oxide≤45 mol %, 37.5 mol %≤strontium oxide≤40 mol %, 42.5 mol %≤strontium oxide≤45 mol %, or any sub-ranges formed by any one of the foregoing starting points and/or endpoints provided herein.

In aspects of this disclosure, the glass-ceramic article, may further comprise minor constituents which are constituents that are individually present in the glass-ceramic article in amounts of 1 mol % or less, 0.5 mol % or less, 0.2 mol % or less, 0.1 mol % or less, or 0.05 mol % or less. The total amount of minor constituents (adding all the minor constituents together) may be present in the glass-ceramic article in an amount of 5 mol % or less, 2 mol % or less, 1 mol % or less, 0.5 mol % or less, 0.2 mol % or less, or 0.1 mol % or less. In aspects of this disclosure, the minor constituents may be magnesium oxide, calcium oxide, barium oxide, sodium oxide, potassium oxide, iron oxide, and/or titanium oxide, among others. In one or more embodiments, the composition of the glass-ceramic article may contain boron oxide (B₂O₃) in an amount up to 5 mol %, e.g., in a range of about 1 mol % to 5 mol %, without affecting the desirable properties of the glass-ceramic article.

In aspects of this disclosure, particularly suitable compositions for the glass-ceramic article include silica (SiO₂), alumina (Al₂O₃), and strontium oxide (SrO) in the ranges of 40 mol %≤silica<50 mol %, 25 mol %≤alumina<35 mol %, and 25 mol %≤strontium oxide<35 mol %; 41 mol %≤silica<50 mol %, 26 mol %≤alumina<35 mol %, and 26 mol %≤strontium oxide<35 mol %; 42 mol %≤silica<50 mol %, 27 mol %≤alumina<35 mol %, and 27 mol %≤strontium oxide<35 mol %; 43 mol %≤silica<50 mol %, 28 mol %≤alumina<35 mol %, and 28 mol %≤strontium oxide<35 mol %; 43 mol %≤silica<50 mol %, 28.5 mol %≤alumina<35 mol %, and 28.5 mol %≤strontium oxide<35 mol %; 43 mol %≤silica<50 mol %, 27.5 mol %≤alumina<35 mol %, and 27.5 mol %≤strontium oxide<35 mol %; 43 mol %≤silica<50 mol %, 27 mol %≤alumina<35 mol %, and 27 mol %≤strontium oxide<35 mol %; 43 mol %≤silica<50 mol %, 26.5 mol %≤alumina<35 mol %, and 26.5 mol %≤strontium oxide<35 mol %; and any sub-ranges formed by any one of the foregoing starting points and/or endpoints provided herein. In one or more embodiments, the amount of alumina is approximately equal to the amount of strontium oxide (e.g., within about 1 mol %) in the composition of the glass-ceramic article. Further, in one or more embodiments, both the amount of alumina and the amount of strontium oxide are less than the amount of silica, in particular each are at least about 5 mol %, about 10 mol %, or about 12 mol % less than the amount of silica.

In aspects of the present disclosure, the transmittance of visible light (e.g., light having a wavelength in the range of 400 nm to 800 nm) in the amorphous interior may be higher than the transmittance of visible light in the crystalline shell; thus, the amorphous interior may be more transparent in the visible light spectrum than the crystalline shell. As such, in aspects of this disclosure, at a thickness of the glass-ceramic article, the transparency of the glass-ceramic article may be increased when the thickness of the shell relative to the thickness of the amorphous interior decreases. When the shell surrounds the amorphous interior, even at least partially, the transparency of the article may also be considered in terms of relative volume of the shell as compared to volume of the amorphous interior, wherein transmittance or transparency of the glass-ceramic article may increase when the volume of the shell relative to the volume of the amorphous interior decreases at a thickness of the glass-ceramic article.

The volume of the shell and/or the volume of the amorphous interior relative to the volume of the glass-ceramic article relates to the transparency of the glass-ceramic article. For a glass-ceramic article of a particular size, an increase in the volume of the amorphous interior or a decrease in the volume of the crystalline shell relative to the volume of the glass-ceramic article may increase transparency of the glass-ceramic article. In aspects of this disclosure, the amorphous interior may be greater than 0% of the volume of the glass-ceramic article but less than 100% of the volume of the glass-ceramic article. In one or more embodiments, the amorphous interior makes up a percentage of the volume of the glass-ceramic article in a range of 10% to <100%, 20% to <100%, 30% to <100%, 40% to <100%, 50% to <100%, 60% to <100%, 70% to <100%, 80% to <100%, 90% to <100%, 10% to 90%, 20% to 90%, 30% to 90%, 40% to 90%, 50% to 90%, 60% to 90%, 70% to 90%, 80% to 90%, 10% to 80%, 20% to 80%, 30% to 80%, 40% to 80%, 50% to 80%, 60% to 80%, 70% to 80%, 10% to 70%, 20% to 70%, 30% to 70%, 40% to 70%, 50% to 70%, 60% to 70%, 10% to 60%, 20% to 60%, 30% to 60%, 40% to 60%, 50% to 60%, 10% to 50%, 20% to 50%, 30% to 50%, 40% to 50%, 10% to 40%, 20% to 40%, 30% to 40%, 10% to 30%, 20% to 30%, 10% to 20%, or any ranges or sub-ranges formed by any one of the foregoing starting points and/or endpoints provided herein. The volume of the crystalline shell is approximately equal to the volume of the glass-ceramic article less the volume of the amorphous interior. Thus, for example, if the amorphous interior comprises 60% of the volume of the glass-ceramic article, the crystalline shell will comprise about 40% of the volume of the glass-ceramic article.

In one or more embodiments, the depth D of the shell 110 of the glass-ceramic article 100 may be at least 5 micrometers and up to 10 micrometers, up to 50 micrometers, up to 100 micrometers, up to 250 micrometers, up to 500 micrometers, up to 1 mm, up to 1.5 mm, or up to 2 mm. In one or more embodiments, the depth D of the shell 110 is up to half the thickness T1 of the glass-ceramic article 100.

A method for forming the glass-ceramic article of the present disclosure may involve creating a melt from the primary constituents that form the glass-ceramic article, and then forming the composition into a glass article using various casting, drawing (e.g., slot draw or fusion draw), float (e.g., on a molten tin bed), and bending processes. Once the glass article is formed comprising constituents, the glass article may be surface nucleated to promote crystal growth, thereby creating the glass-ceramic article. The crystal growth starts at and extends from the surface of the glass-ceramic article and extending into the glass-ceramic article. As discussed above, the crystal growth may be oriented normal to the surface of the glass-ceramic article. In one or more embodiments, the crystals may or may not grow perfectly normal to the surface, such as, for example, the crystals may grow less than or equal to 15 degrees from normal to the surface. In one or more embodiments, the crystal growth may be stopped when the crystals have extended to at least 5 micrometers lengthwise. Further, in one or more embodiments to produce a glass-ceramic article, the crystal growth is stopped before extending to the center of the glass-ceramic article so as to leave an amorphous interior in the glass-ceramic article. However, according to one or more other embodiments in which a crystalline article is produced, as discussed below, the crystal growth is allowed to continue until the crystals meet at approximately the midline of the article. Crystal growth normal to the surface is ideal because transparency is enhanced through crystals substantially parallel to a viewing plane in which the viewing plane is perpendicular to a surface of a given glass-ceramic article. Thus, the more normal to the surface that the crystal growth is for each columnar crystal, the better transparency will be from the viewing plane.

Nucleation of the crystals may involve heat-treating the glass article formed from the primary constituents. Heat treatment may take place in a furnace or any other suitable apparatus for applying heat to the glass article to form the glass-ceramic article. For certain example embodiments discussed in greater detail below, differential scanning calorimetry (DSC) was used to characterize the glass-ceramic article for performing the nucleation process. Differential scanning calorimetry (DSC) may measure the difference in heat flow needed to increase the temperature of a gram of a sample and a reference material as a function of temperature, which may be expressed as milliwatts per milligram (mW/mg) versus degrees Celsius (° C.). DSC is measured in a controlled atmosphere, wherein the measurements indicate changes involving endothermic and exothermic processes (such as the exothermic process of crystallization). The glass article was placed in a DSC instrument and measured via a corresponding software to gather onset temperatures (temperatures at which melting/crystallization commences) and peak temperatures (temperatures where heat flow by mass for a given sample reaches a maximum point). In one or more embodiments, the exothermic onset temperature, as measured by DSC, is in the range of 1010° C. to 1080° C., 1020° C. to 1070° C., 1030° C. to 1060° C., 1040° C. to 1050° C., 1010° C. to 1020° C., 1020° C. to 1030° C., 1030° C. to 1040° C., 1050° C. to 1060° C., 1060° C. to 1070° C., 1070° C. to 1080° C., or any range or sub-ranges formed by any one of the foregoing starting points and/or endpoints provided herein. In one or more embodiments, the exothermic peak temperature, as measured by DSC, is in the range of 1060° C. to 1130° C., 1070° C. to 1120° C., 1080° C. to 1110° C., 1080° C. to 1100° C., 1060° C. to 1070° C., 1070° C. to 1080° C., 1080° C. to 1090° C., 1090° C. to 1100° C., 1100° C. to 1110° C., 1110° C. to 1120° C., or any range or sub-ranges formed by any one of the foregoing starting points and/or endpoints provided herein. If heat treatment is performed too low below the onset temperature, such as lower than 1010° C., then nucleation may fail to begin. If heat treatment is performed too far above the exotherm peak temperature, such as higher than 1130° C., defects may form during the nucleation process.

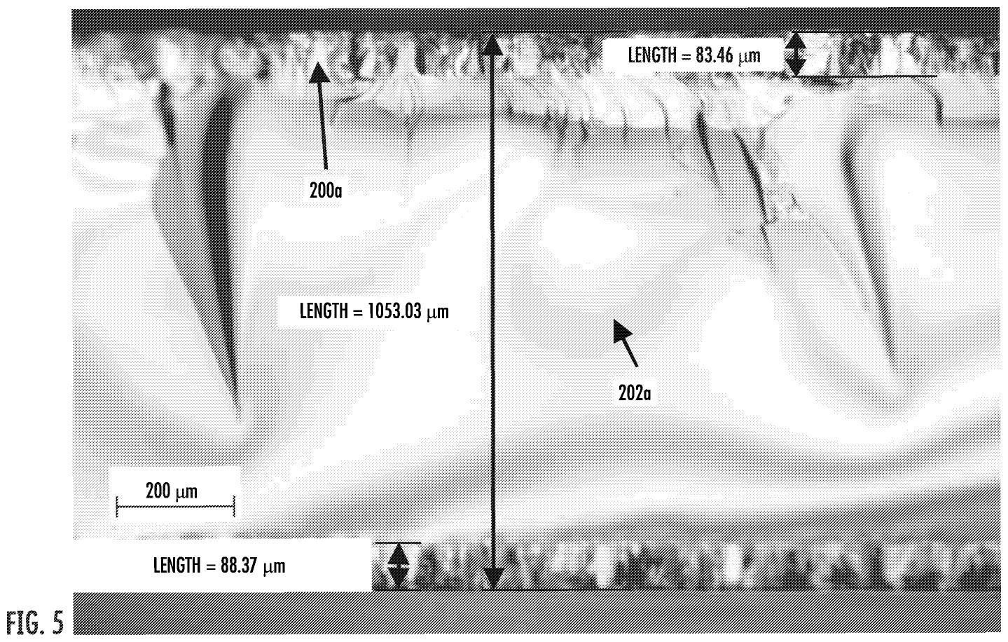

During heat treatment, the longer the glass-ceramic article is heat treated, the further the nucleation process progresses, meaning that the thickness of the shell increases as the glass-ceramic article as the heat treatment time increases. As shown in FIGS. 5-8, increasing heat-treatment time of a glass-ceramic article increases the depth of the crystalline shell relative to the amorphous interior (wherein, the shell is heat treated from 1 hour and 3 minutes to 4 hours and 36 minutes at 1050° C.). In aspects of this disclosure, heat treatment may take place for greater than or equal to 1 hour and less than or equal to 5 hours. The required time of heat treatment to achieve a desired ratio of amorphous interior thickness to shell thickness may depend on the overall thickness of the glass-ceramic article. Notwithstanding the foregoing, depending on the thickness of the glass-ceramic article, and depending on the desired level of crystallinity, heat treatment may take place for greater than 0 hours and less than 1 hour or greater than 5 hours.

Heat treating the glass-ceramic article to form the shell may result in surface texture such as surface roughness on, e.g., the first major surface and/or the second major surface of the glass-ceramic article. Surface texture may reduce the transmittance through the glass, decreasing transparency. In one or more embodiments, such surface texture is removed from the glass-ceramic article by polishing the glass-ceramic article. Polishing may be any means of smoothing a surface of a glass-ceramic article or reducing surface texture by abrading the surface and/or thinning down the glass-ceramic article at the surface (even if said thinning down is slight). For glass-ceramic articles with flat, round, and/or other surfaces, the glass-ceramic article may be polished to produce a shape (including, but not limited to, a round shape, a rounded shape, and/or a flat shape) with a smooth surface. Because polishing occurs on the surface of the glass-ceramic article, polishing may occur, at least in part, on the shell. Polishing the glass article may have advantageous effects in terms of increasing transparency as well as preparing the glass-ceramic article for processes such as sealing and coating to make such processes easier to perform on the glass-ceramic article.

To test the crack resistance of the shell, any of various indentation tests may be performed on shell, especially after the surface has been polished to sufficiently remove surface texture. In one or more embodiments, the hardness test is a Vickers hardness test during which an indentation is formed on the surface of the glass-ceramic article from which the hardness and crack resistance of the crystalline shell can be determined. As will be discussed more fully below, the crystals of the shell enhance crack resistance by creating a tortuous path for propagation of the crack. At a preset kgf value, the Vicker's hardness tester may indent the shell with a predetermined force that is substantial enough to propagate cracks in an embodiment of the article. In one or more embodiments, the shell will exhibit tortuous crack paths when indented, which limit the propagation of the crack and limit crack extension. Said tortuous paths may relate to the normal orientation of the columnar crystals of the shell relative to the surfaces of the glass-ceramic article.

The glass-ceramic article may exhibit high transparency as shown in FIG. 1B, even in embodiments where the crystals fully extend to the middle of the article as will be discussed more fully below. In one or more embodiments, the glass-ceramic article is a sheet that acts as transparent cover for a display device, such as an electronic device (e.g., laptop screen, tablet, cellular device, etc.), an appliance (e.g., stove top, oven door, refrigerator, microwave, etc.), or an architectural panel (e.g., window, divider, etc.), among other possibilities.

When viewing the glass-ceramic article at an angle that is not substantially parallel to the direction of the crystal growth, transparency may not be as high as it would be if viewed in a direction parallel to the crystal growth. Thus, applications of the glass-ceramic article in this disclosure may be utilized in devices or architectural items or structures that require privacy when looking at the glass-ceramic article at an angle away from normal to the surface of the glass-ceramic article, such as a tablet device or a window.

### Exemplary Embodiments

Glass compositions that are effective in producing the glass-ceramic article described herein were formed based on mol % ranges of constituents listed in Table 1. Labels 149AHI, 149AHJ, and 149AHK each represent glass-ceramic articles composed via different mol % ranges of the primary constituents. “Batched mol %” of Table 1 shows mol % ranges for each of the primary constituents used in the glass-ceramic article as a matter of theoretical amounts. “Analyzed mol %” of Table 1 shows mol % ranges for each of the primary constituents used in the glass-ceramic article as a matter of actual amounts. The data of Table 1 was rounded to the hundredth's place, and error assumed from rounding accounts for an extra 0.01 mol % for 149AHI and a missing 0.01 mol % for 149AHJ.

TABLE 1
Compositions and Properties of Glass-
Ceramic Materials Investigated

| | 149AHI | 149AHJ | 149AHK |
|---|---|---|---|
| batched mol % | | | |
| SiO₂ | 45 | 42.5 | 40 |
| Al₂O₃ | 27.5 | 28.75 | 30 |
| SrO | 27.5 | 28.75 | 30 |
| analyzed mol % | | | |
| SiO₂ | 46.19 | 43.25 | 41.12 |
| Al₂O₃ | 27.25 | 28.51 | 29.87 |
| SrO | 26.42 | 28.08 | 28.86 |
| minor constituents (MgO, | 0.15 | 0.15 | 0.15 |
| CaO, BaO, Na₂O, K₂O, | | | |
| Fe₂O₃, TiO₂) | | | |

Physical property data

| | | | |
|---|---|---|---|
| Density of glass (g/cm³) | 3.091 | 3.129 | 3.155 |
| Young's modulus of glass | 89.6 | 90.7 | 91.9 |
| (GPa) | | | |
| XRD of crystallized material | SrAl₂Si₂O₈ | SrAl₂Si₂O₈ | SrAl₂Si₂O₈ |
| DSC exotherm onset temp | 1037 | 1049 | 1049 |
| (° C.) | | | |
| DSC exotherm peak temp | 1087 | 1096 | 1104 |
| (° C.) | | | |

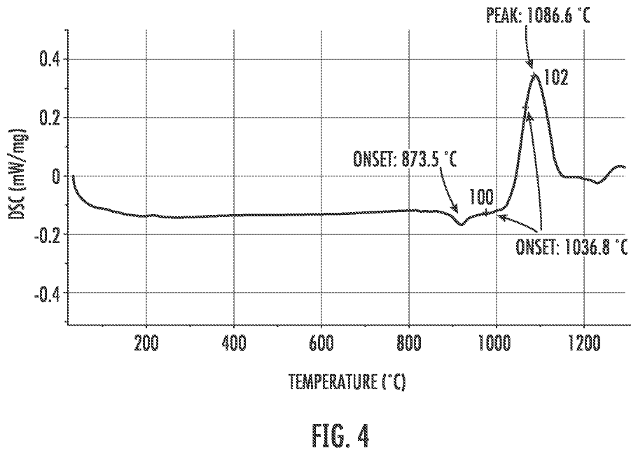

In glass-ceramic article formed from the 149AHI composition (also referred to as just “149AHI” or “149AHI specimen”), the glass-ceramic article had a thickness of approximately 0.8 mm and a density of 3.091 g/cm³. FIG. 4 shows how DSC values changed with temperature as 149AHI was heat treated. Onset 100 in FIG. 4 displays a DSC exotherm onset temperature of about 1037° C., the point where DSC values began rapidly increasing for 149AHI. Peak 102 in FIG. 4 also shows that DSC values maximized at approximately 1087° C. for 149AHI.

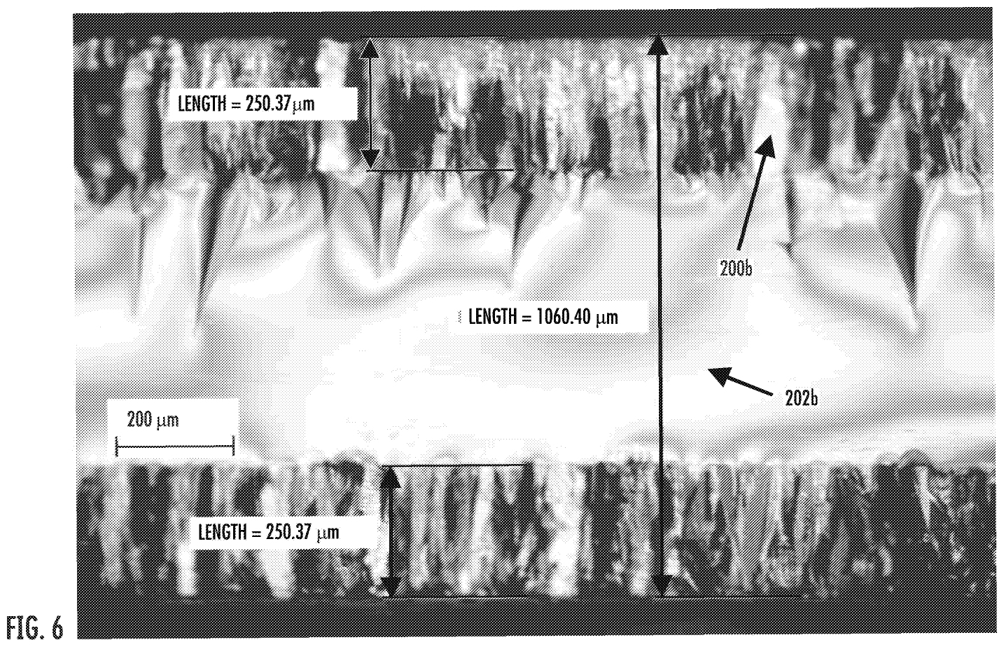

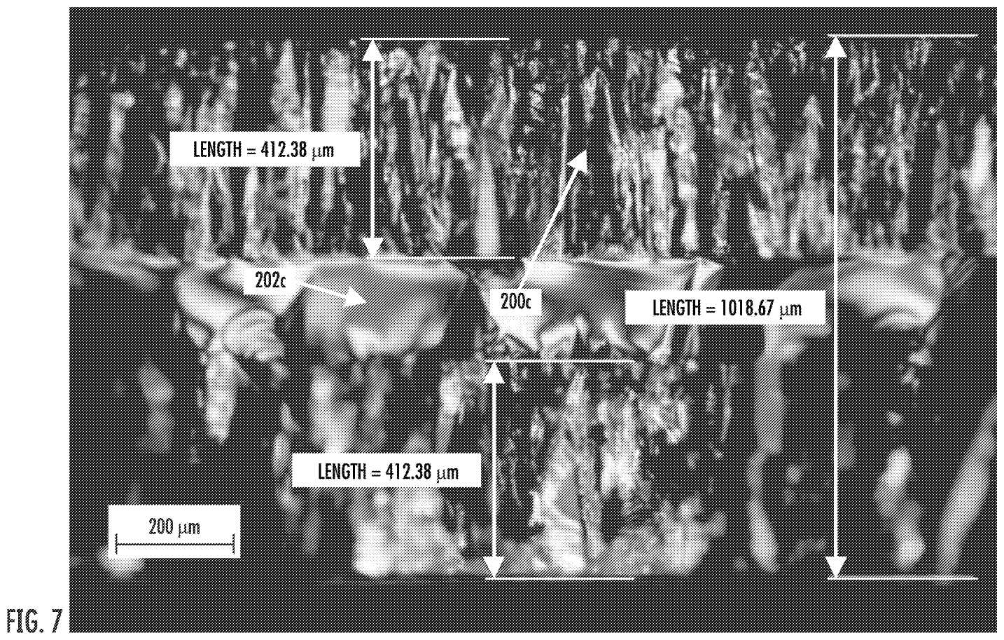

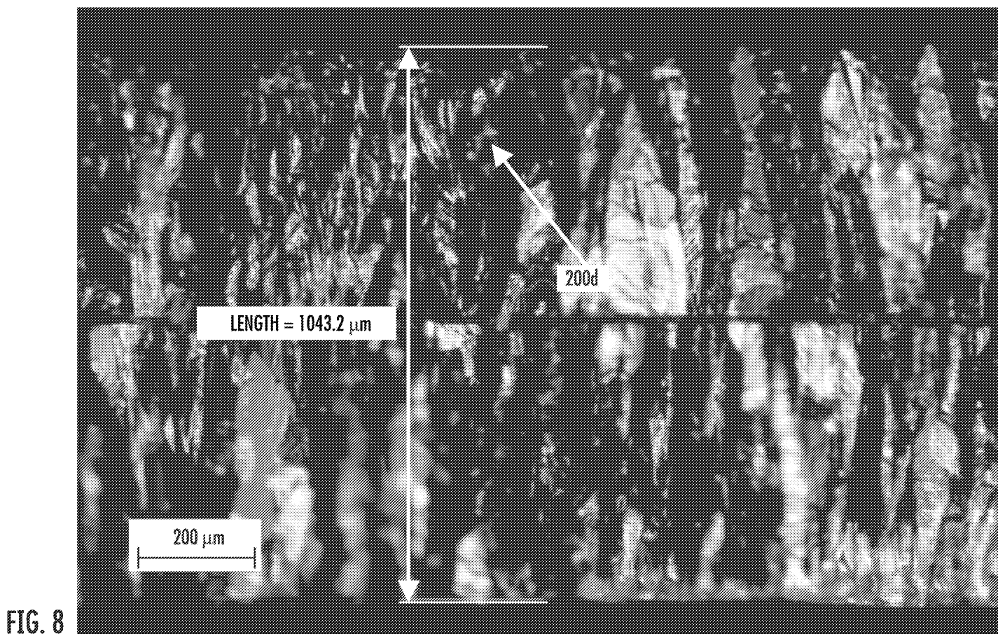

For 149AHI, heat treatment occurred at 1050° C. to promote nucleation at surfaces of the article, wherein shell of 149AHI grew larger as heat treatment extended longer. For FIGS. 5-8, four points during heat treatment were observed and recorded as time progressed: 1 hour, 3 minutes (FIG. 5), 2 hours, 33 minutes (FIG. 6), 3 hours, 45 minutes (FIG. 7), and 4 hours, 36 minutes (FIG. 8). FIGS. 5-8 show the progression of the depth of the shells 200a, 200b, 200c, 200d as heat treatment continued for 149 AHI. Interiors 202a, 202b, and 202c show a progression of the decrease in amorphous interior of 149AHI. the shell grew deeper as time progressed, and the crystals continued to grow substantially orthogonal to the surface. In FIG. 8, the shell grew after heat treatment for 4 hours and 36 minutes to the extent where there was no amorphous interior, i.e., the sample was fully crystalline.

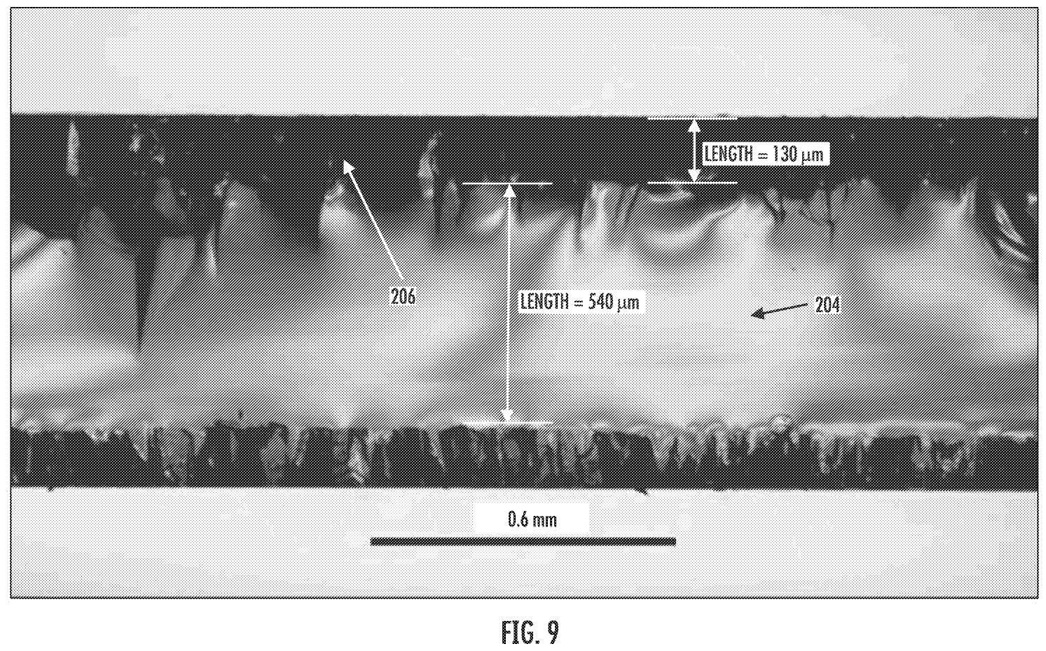

Similar to FIGS. 5-7, FIG. 9 shows a cross-sectional view of a glass-ceramic composite material made from the 149AHI composition when the glass-ceramic article was heat treated for 2 hours, 30 minutes to create a glass-ceramic composite material with a shell 206 having a depth from each surface of 130-micrometer. In that the total thickness of the glass-ceramic article was 0.8 mm, the interior 204 was 540 micrometers.

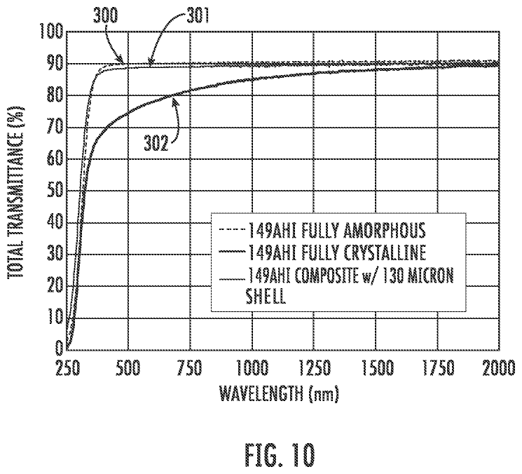

Transmittance values were recorded for 149AHI at various stages of heat treatment, including fully amorphous (i.e., not yet heat-treated), 130-micrometer shell thickness and 540-micrometer amorphous interior thickness, and fully crystalline (i.e., no amorphous interior). FIG. 10 shows a graph of total transmittance vs. wavelength for 149AHI. As shown by curves 300 and 301 in FIG. 10, the glass-ceramic article had a transmittance curve that substantially overlapped the curve for a fully amorphous glass, indicating that a composite material with a 130-micrometer shell exhibits a high transparency comparable to a high transparency of a typical, glassy substrate. As shown by curve 302 in FIG. 10, the fully crystalline version of 149AHI still exhibited relatively high transmittance and transparency in the visible light spectrum, wherein, for instance, the fully crystalline version exhibited a total transmittance of about 75% for visible light having a wavelength as low as 500 nm. Moreover, the fully crystalline version exhibited a total transmittance of over 60% for light having a wavelength as low as about 375 nm. As will be discussed more fully below, Applicant has found ways to enhance the transparency of a fully crystalline article based on substantially reducing or eliminating secondary phases during crystal nucleation and growth.

The degree of visibility for a particular transmittance may be subjective to a viewer, but in general, a transmittance over 30% in the visible light spectrum may be considered reasonable transparency for certain applications. For most applications, a transmittance of 50% or 60% provides sufficient transparency. Thus, the transmittance of over 80% including for wavelengths as low as about 380 nm for the glass-ceramic article of 149AHI is expected to be suitable for display applications.

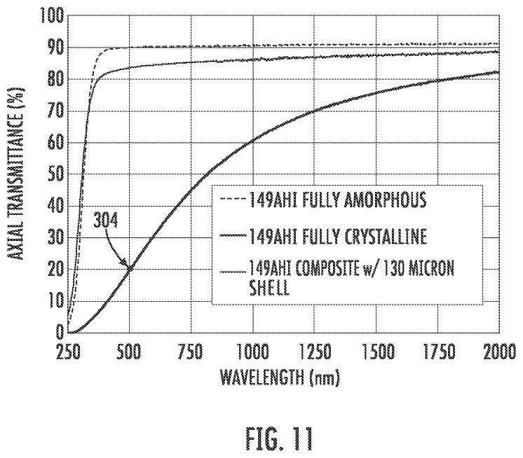

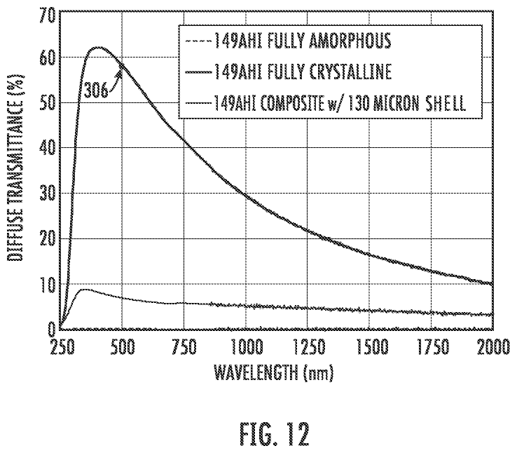

FIGS. 11 and 12 show that axial transmittance is relatively low in the visible light spectrum for the fully crystalline version of 149AHI. For example, point 304 in FIG. 11 indicates that the axial transmittance for light having a wavelength of 500 nm is only about 20%. However, point 306 in FIG. 12 indicates that diffuse transmittance is relatively high in the visible spectrum, including almost 60% at 500 nm. In contrast, the glass-ceramic version of 149AHI performed similar to the fully amorphous version of 149AHI in terms of axial transmittance (>80% transmittance over the visible spectrum) and diffuse transmittance (<10% transmittance over the visible spectrum).

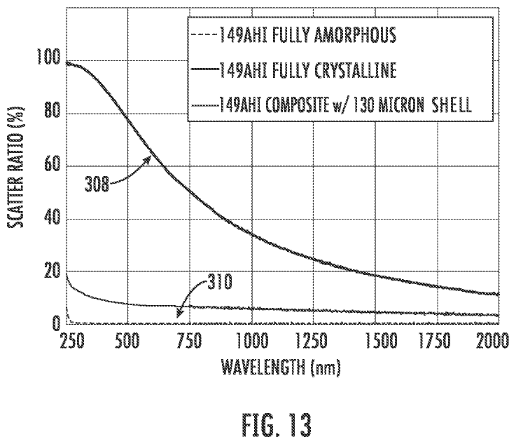

FIG. 13 depicts the scatter ratio for the fully amorphous, fully crystalline, and glass-ceramic versions of 149AHI. The scatter ratio for fully crystalline version was significantly higher in the visible light spectrum (see curve 308 in FIG. 13) than for the amorphous and glass-ceramic versions. Crystals in the shell promoted greater light scattering in the visible light spectrum for the fully crystalline version, as opposed to an amorphous glass which exhibited nearly no light scattering in the visible light spectrum (and, hence, the scatter ratio of the fully amorphous version is near 0% in the visible light spectrum [see curve 310 in FIG. 13]). The scatter ratio for the glass-ceramic version was well below 20% and even below 10% for much of the visible spectrum.

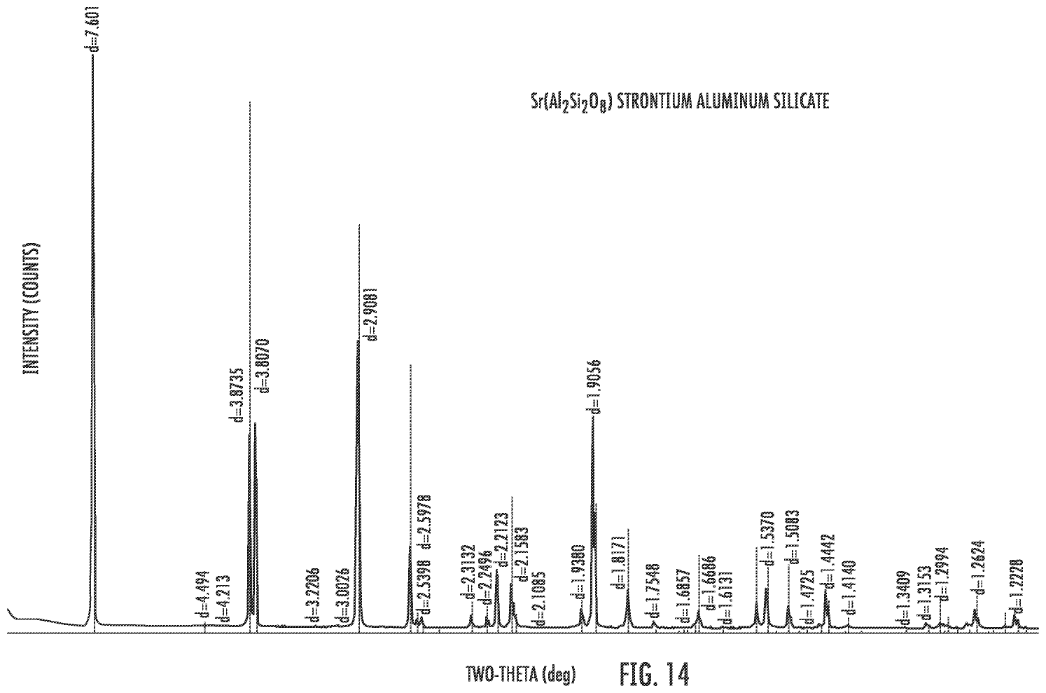

FIG. 14 shows the X-Ray Diffraction intensity vs. 20 for the fully crystalline 149AHI specimen (i.e., after heat treatment for 4 hours 36 minutes at 1050° C. so that surface crystal growth of the 149AHI specimen met at the center to create a fully crystalline version, leaving little, if any, amorphous content). The fully crystalline version had a diffraction pattern highly emblematic of a crystal structure, given that an amorphous or glassy structure would have a much more consistent curve, as opposed to the large and distinct spikes along the 20 axis seen in the graph in FIG. 14. Further, the diffraction pattern was a strong match for Sr(Al₂Si₂O₈), although as will be discussed below secondary crystal phases may also have been present based on the thickness of the fully crystalline sample analyzed.

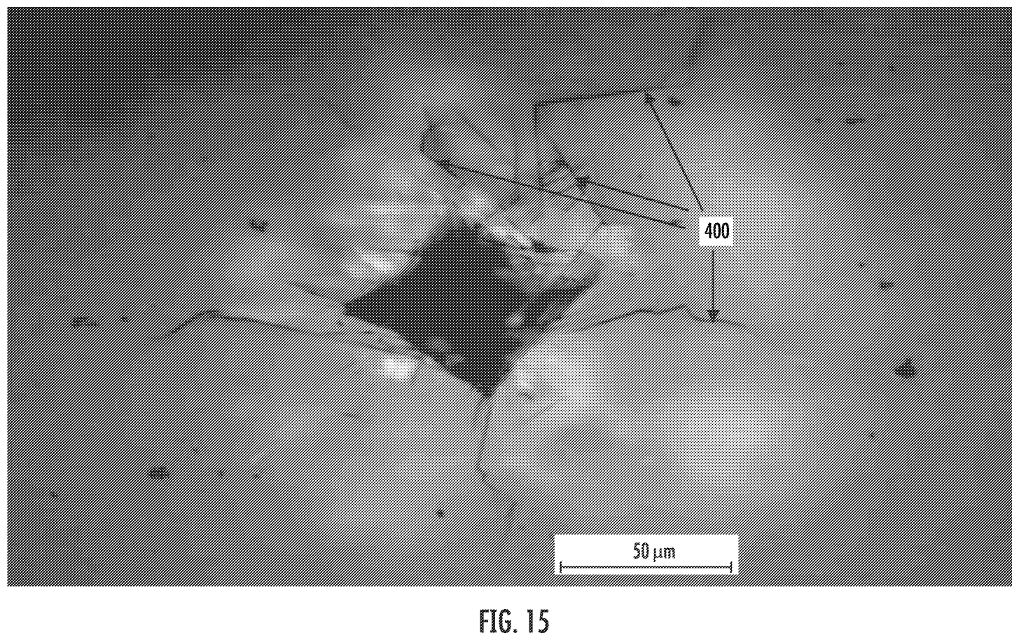

The cracking path of embodiments of the glass-ceramic article was examined to understand crack resistance of the article. FIG. 15 shows a Vickers indentation on the fully crystalline version of 149AHI. Prior to indentation, the surface was polished to remove 100 micrometers from the surface, eliminating any surface texture created during heat treatment. The shell in the exemplary embodiment discussed in this paragraph was approximately 421.61 micrometers thick (which is the combined shells in FIG. 8 divided by 2 and then subtracted by 100 micrometers of polishing). Cracks 400 in FIG. 15 show that cracks caused by the indentation follow a tortuous path. As described in this disclosure, a tortuous cracking path is more likely than a straight cracking to reduce crack propagation in a glass-ceramic article. As can be seen in FIG. 15, tortuous cracks 400 were created, at least in part, by the columnar crystal growth extending from the surface of the glass-ceramic article.

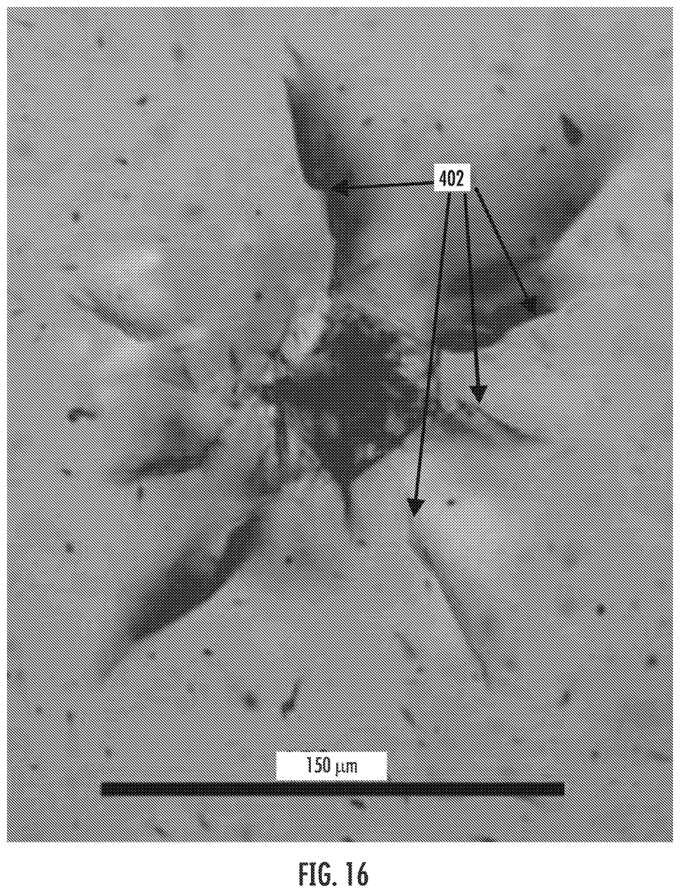

Similarly, FIG. 16 shows a Vickers indent applied to 149AHI as a glass-ceramic composite material heat treated for 2 hours, 30 minutes and polished to yield a 130-micrometer shell and a 540-micrometer amorphous interior. Similar to FIG. 15, the composite material in FIG. 16 had a tortuous crack path (see cracks 402 in FIG. 16), suggesting greater crack resistance in the shell of the glass-ceramic composite material than an amorphous glass of the same composition.

In addition to the composite glass-ceramic article having an amorphous interior and crystalline shell, Applicant has found that a fully crystalline version can also be suitable for use as a transparent display. In particular, by maintaining the SiO₂—Al₂O₃—SrO glass composition within slightly narrower limits and by limiting the thickness of the article to 1 mm or less, the transparency of a fully crystalline article can be enhanced. More particularly, the crystalline article is substantially a single crystal phase, in particular Sr(Al₂Si₂O₈), with minimal formation of secondary phase crystals, such as SrSiO₃, that can diminish transparency and degrade mechanical reliability. As will be discussed more fully below, the crystalline articles are produced by nucleating columnar crystals from the surfaces of a glass article until the columnar crystals meet at approximately the midpoint of the thickness of the glass article.

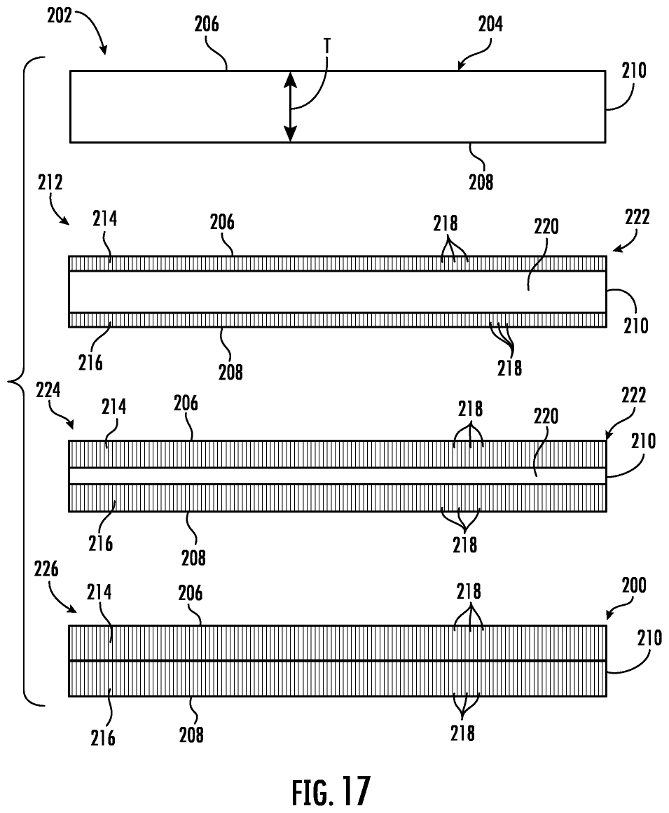

FIG. 17 depicts stages of development of a crystalline article 200, which substantially corresponds to the discussion above. In a first stage 202, an amorphous glass article 204 is provided. As discussed above and as will be discussed more fully below, the amorphous glass article 204 is comprised primarily of silica (SiO₂), alumina (Al₂O₃), and strontium oxide (SrO). The amorphous glass article 204 includes a first major surface 206 and a second major surface 208. The second major surface 208 is opposite to the first major surface 206, and the distance between the first major surface 206 and the second major surface 208 defines a thickness T of the amorphous glass article 204. A minor surface 210 connects the first major surface 206 to the second major surface 208.

The amorphous glass article 204 is heat treated such that, as shown in a second stage 212, crystalline regions 214, 216 (akin to the shell 110 discussed above) nucleate at the first major surface 206 and the second major surface 208, respectively. In one or more embodiments, the crystalline regions 214, 216 are formed via heterogeneous nucleation, absent of nucleating agents. In other words, and more specifically, the crystalline regions 214, 216 are surface nucleated, e.g., from defects in the first major surface 206, the second major surface 208, and the minor surface 210, to promote inward crystal growth which creates columnar crystals 218. While not specifically shown in FIG. 17, crystalline regions do also form at the minor surface 210. The crystallized regions 214, 216 are defined by columnar crystals 218 that extend from the respective first and second major surfaces 206, 208 into the depth of an amorphous region 220. The formation of the crystalline regions 214, 216 transforms the amorphous glass article 204 into a glass-ceramic article 222.

Consistent with the discussion above, the description of the crystals 218 as “columnar” is meant to convey that the crystals have a high aspect ratio (height to width), such as at least 2:1, at least 10:1, at least 20:1, or at least 50:1, and are oriented substantially normal to the respective first and second major surfaces 206, 208, e.g., within 15 degrees of normal. As discussed above, the normal, or near normal, orientation of the columnar crystals 218 in the crystalline regions 214, 216 creates relatively high transparency for the crystalline regions 114, 116 and improves radial crack resistance as compared, e.g., to randomly oriented crystals (which may be produced through heterogeneous nucleation using nucleating agents and/or through homogeneous nucleation within the glass-ceramic article 222).

As the glass-ceramic article 222 continues to be heat-treated, the crystalline regions 214, 216 continue to grow into the depth of the amorphous region 220, shrinking the amorphous region 220, as shown in a third stage 224. As the heat treatment progresses, the crystalline regions 214, 216 grow until they meet as shown in a fourth stage 226, producing the crystalline article 200. As can be seen in FIG. 17, the amorphous region 220 is substantially if not entirely removed from the crystalline article 200. In this way, the crystalline regions 214, 216 nucleate at the respective first and second major surfaces 206, 208 and grow until they meet at approximately a midline of the thickness T.

In one or more embodiments, each crystalline region 214, 216 is at least 90 vol % crystalline phase, at least 92 vol % crystalline phase, at least 94 vol % crystalline phase, at least 96 vol % crystalline phase, at least 98 vol % crystalline phase, or greater than 99 vol % crystalline phase. In one or more embodiments, each crystalline region 214, 216 comprises 100 vol % crystalline phase. Further, in one or more embodiments, crystalline article 200 is overall at least 90 vol % crystalline phase, at least 92 vol % crystalline phase, at least 94 vol % crystalline phase, at least 96 vol % crystalline phase, at least 98 vol % crystalline phase, or greater than 99 vol % crystalline phase. In one or more embodiments, the crystalline article 200 overall comprises 100 vol % crystalline phase. In one or more embodiments, the crystalline article 200 is overall 10 vol % or less amorphous phase, 8 vol % or less amorphous phase, 6 vol % or less amorphous phase, 4 vol % or less amorphous phase, 2 vol % or less amorphous phase, or 1 vol % or less amorphous phase. In one or more embodiments, the crystalline article 200 comprises no amorphous phase.

As mentioned above, the crystalline article primarily is comprised of silica, alumina, and strontium oxide (together, the “primary constituents”). In one or more embodiments, the primary constituents comprise at least 85 mol % of the crystalline article 200, at least 87.5 mol % of the crystalline article 200, at least 90 mol % of the crystalline article 200, at least 92.5 mol % of the crystalline article 200, at least 95 mol % of the crystalline article 200, at least 97.5 mol % of the crystalline article 200, or up to 100 mol % of the crystalline article 200. In one or more embodiments, the crystalline article 200 comprises the primary constituents in an amount in a range of 85 mol % to 100 mol %, 87.5 mol % to 100 mol %, 90 mol % to 100 mol %, 92.5 mol % to 100 mol %, 95 mol % to 100 mol %, 97.5 mol % to 100 mol %, or any ranges or subranges between the foregoing endpoints.

As mentioned above, the crystalline article 200 can be formed from a glass composition that can be considered a subset of the broader composition disclosed as suitable for forming a glass-ceramic article having an amorphous interior. In one or more embodiments, the composition of the crystalline article includes 40 mol % to 50 mol % silica (SiO₂) and alumina (Al₂O₃) is present in a greater amount, up to 5 mol % greater, than strontium oxide (SrO), i.e., 0 mol %<Al₂O₃—SiO₂≤5 mol %.

In one or more embodiments, the crystalline article 200 may comprise silica (SiO₂) in an amount in the range of 40 mol %≤silica≤50 mol %, 41 mol %≤silica≤50 mol %, 42 mol %≤silica≤50 mol %, 43 mol %≤silica≤50 mol %, 44 mol %≤silica≤50 mol %, 45 mol %≤silica≤50 mol %, 46 mol %≤silica≤50 mol %, 47 mol %≤silica≤50 mol %, 48 mol %≤silica≤50 mol %, 49 mol %≤silica≤50 mol %, 40 mol %≤silica≤49 mol %, 41 mol %≤silica≤49 mol %, 42 mol %≤silica≤49 mol %, 43 mol %≤silica≤49 mol %, 44 mol %≤silica≤49 mol %, 45 mol %≤silica≤49 mol %, 46 mol %≤silica≤49 mol %, 47 mol %≤silica≤49 mol %, 48 mol %≤silica≤49 mol %, 40 mol %≤silica≤48 mol %, 41 mol %≤silica≤48 mol %, 42 mol %≤silica≤48 mol %, 43 mol %≤silica≤48 mol %, 44 mol %≤silica≤48 mol %, 45 mol %≤silica≤48 mol %, 46 mol %≤silica≤48 mol %, 47 mol %≤silica≤48 mol %, 40 mol %≤silica≤47 mol %, 41 mol %≤silica≤47 mol %, 42 mol %≤silica≤47 mol %, 43 mol %≤silica≤47 mol %, 44 mol %≤silica≤47 mol %, 45 mol %≤silica≤47 mol %, 46 mol %≤silica≤47 mol %, 40 mol %≤silica≤46 mol %, 41 mol %≤silica≤46 mol %, 42 mol %≤silica≤46 mol %, 43 mol %≤silica≤46 mol %, 44 mol %≤silica≤46 mol %, 45 mol %≤silica≤46 mol %, 40 mol %≤silica≤45 mol %, 41 mol %≤silica≤45 mol %, 42 mol %≤silica≤45 mol %, 43 mol %≤silica≤45 mol %, 44 mol %≤silica≤45 mol %, 40 mol %≤silica≤44 mol %, 41 mol %≤silica≤44 mol %, 42 mol %≤silica≤44 mol %, 43 mol %≤silica≤44 mol %, 40 mol %≤silica≤43 mol %, 41 mol %≤silica≤43 mol %, 42 mol %≤silica≤43 mol %, 40 mol %≤silica≤42 mol %, 41 mol %≤silica≤42 mol %, 40 mol %≤silica≤41 mol %, and any ranges or sub-ranges formed by any one of the foregoing starting points and/or endpoints provided herein.

In aspects of this disclosure, the crystalline article 200 may comprise alumina (Al₂O₃) in the range of 25 mol %≤alumina≤32.5 mol %, such as 26 mol %≤alumina≤32.5 mol %, 27 mol %≤alumina≤32.5 mol %, 28 mol %≤alumina≤32.5 mol %, 29 mol %<alumina≤32.5 mol %, 30 mol %≤alumina≤32.5 mol %, 31 mol %≤alumina≤32.5 mol %, 32 mol %≤alumina≤32.5 mol %, 25 mol %≤alumina≤31 mol %, 26 mol %≤alumina≤31 mol %, 27 mol %≤alumina≤31 mol %, 28 mol %≤alumina≤31 mol %, 29 mol %≤alumina≤31 mol %, 30 mol %≤alumina≤31 mol %, 25 mol %≤alumina≤30 mol %, 26 mol %≤alumina≤30 mol %, 27 mol %≤alumina≤30 mol %, 28 mol %≤alumina≤30 mol %, 29 mol %≤alumina≤30 mol %, 25 mol %≤alumina≤29 mol %, 26 mol %≤alumina≤29 mol %, 27 mol %≤alumina≤29 mol %, 28 mol %≤alumina≤29 mol %, 25 mol %≤alumina≤28 mol %, 26 mol %≤alumina≤28 mol %, 27 mol %≤alumina≤28 mol %, 25 mol %≤alumina≤27 mol %, 26 mol %≤alumina≤27 mol %, 25 mol %≤alumina≤26 mol %, or any ranges and sub-ranges formed by any one of the foregoing starting points and/or endpoints provided herein.

In aspects of this disclosure, the crystalline article 200 may comprise strontium oxide (SrO) in the range of 22.5 mol %≤strontium oxide≤30 mol %, such as 23 mol %≤strontium oxide≤30 mol %, 24 mol %≤strontium oxide≤30 mol %, 25 mol %≤strontium oxide≤30 mol %, 26 mol %≤strontium oxide≤30 mol %, 27 mol %≤strontium oxide≤30 mol %, 28 mol %≤strontium oxide≤30 mol %, 29 mol %≤strontium oxide≤30 mol %, 22.5 mol %≤strontium oxide≤29 mol %, 23 mol %≤strontium oxide≤29 mol %, 24 mol %≤strontium oxide≤29 mol %, 25 mol %≤strontium oxide≤29 mol %, 26 mol %≤strontium oxide≤29 mol %, 27 mol %≤strontium oxide≤29 mol %, 28 mol %≤strontium oxide≤29 mol %, 22.5 mol %≤strontium oxide≤28 mol %, 23 mol %≤strontium oxide≤28 mol %, 24 mol %≤strontium oxide≤28 mol %, 25 mol %≤strontium oxide≤28 mol %, 26 mol %≤strontium oxide≤28 mol %, 27 mol %≤strontium oxide≤28 mol %, 22.5 mol %≤strontium oxide≤27 mol %, 23 mol %≤strontium oxide≤27 mol %, 24 mol %≤strontium oxide≤27 mol %, 25 mol %≤strontium oxide≤27 mol %, 26 mol %≤strontium oxide≤27 mol %, 22.5 mol %≤strontium oxide≤26 mol %, 23 mol %≤strontium oxide≤26 mol %, 24 mol %≤strontium oxide≤26 mol %, 25 mol %≤strontium oxide≤26 mol %, 22.5 mol %≤strontium oxide≤25 mol %, 23 mol %≤strontium oxide≤25 mol %, 24 mol %≤strontium oxide≤25 mol %, 22.5 mol %≤strontium oxide≤24 mol %, 23 mol %≤strontium oxide≤24 mol %, 22.5 mol %≤strontium oxide≤23 mol %, or any sub-ranges formed by any one of the foregoing starting points and/or endpoints provided herein.

Consistent with the disclosure above, the composition used to form the crystalline article 200 may further comprise minor constituents which are constituents that are individually present in the glass-ceramic article in amounts of 1 mol % or less, 0.5 mol % or less, 0.2 mol % or less, 0.1 mol % or less, or 0.05 mol % or less. The total amount of minor constituents (adding all the minor constituents together) may be present in the crystalline article 200 in an amount of 5 mol % or less, 2 mol % or less, 1 mol % or less, 0.5 mol % or less, 0.2 mol % or less, or 0.1 mol % or less. In aspects of this disclosure, the minor constituents may be magnesium oxide, calcium oxide, barium oxide, sodium oxide, potassium oxide, iron oxide, and/or titanium oxide, among others. In one or more embodiments, the composition of the crystalline glass-ceramic article 100 may contain boron oxide (B₂O₃) in an amount up to 5 mol %, e.g., in a range of about 1 mol % to 5 mol %, without affecting the desirable properties of the crystalline article 200.

The method for forming the crystalline article 200 of the present disclosure is substantially the same as described above in relation to the glass-ceramic article. However, heat treatment continues until the crystalline regions 214, 216 meet at substantially the midline of the thickness of the crystalline article 200. After heat treatment, the first major surface and/or the second major surface of the crystalline article 200 may be polished to remove surface texture and increase transmittance as discussed above.

While FIG. 17 depicts a substantially planar (e.g., sheet-like) crystalline article 200, the crystalline article 200 may nevertheless be formed in a range of sizes and shapes. In one or more other embodiments, the crystalline article 200 may be a rectangular article. In one or more embodiments, the crystalline article 200 may be a round article, such as a sphere or a spheroid. In still one or more other embodiments, the crystalline article 200 may have a combination of round and flat surfaces, such as a hemisphere. Applications for which the crystalline article may be used are the same as described above in relation to the glass-ceramic article.

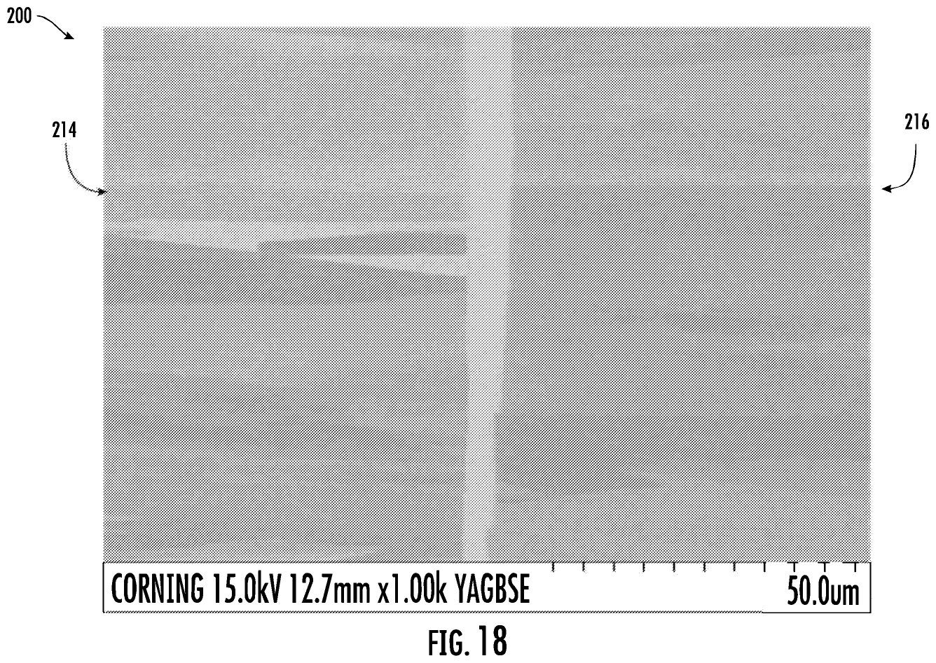

FIG. 18 depicts an SEM micrograph of the interface between crystalline regions 214, 216 for a crystalline article 200 having a thickness of 0.53 mm. The 149AHI composition was used to form the crystalline article 200. To form the crystalline regions 214, 216, the amorphous glass was held at 1070° C. for 133 minutes.

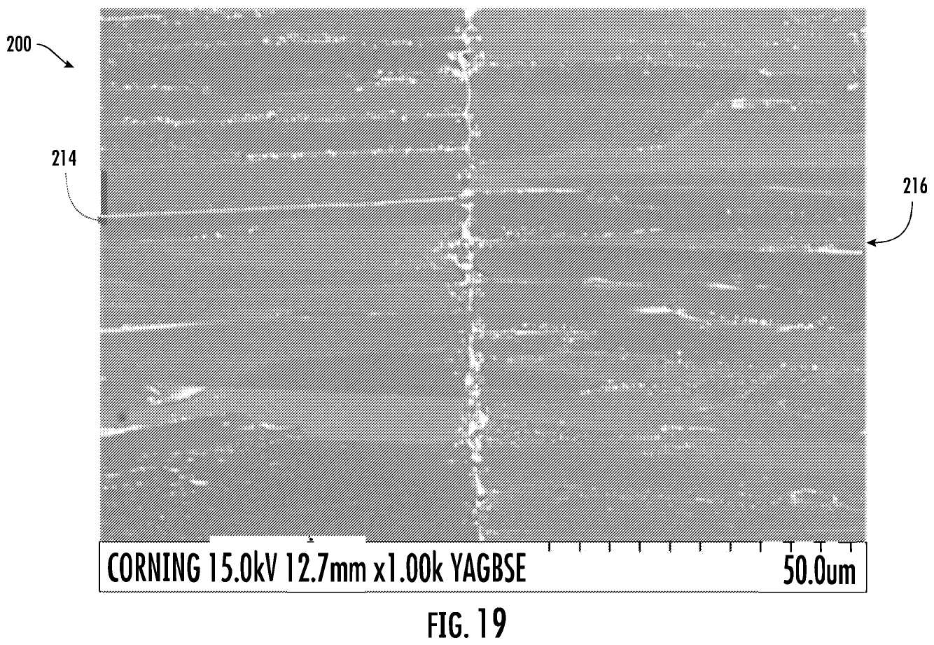

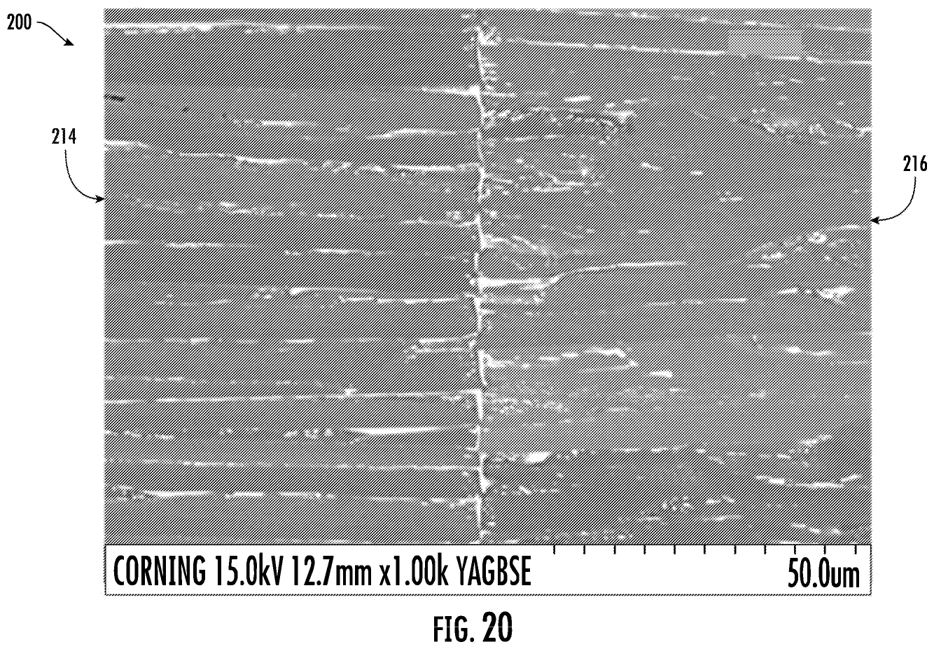

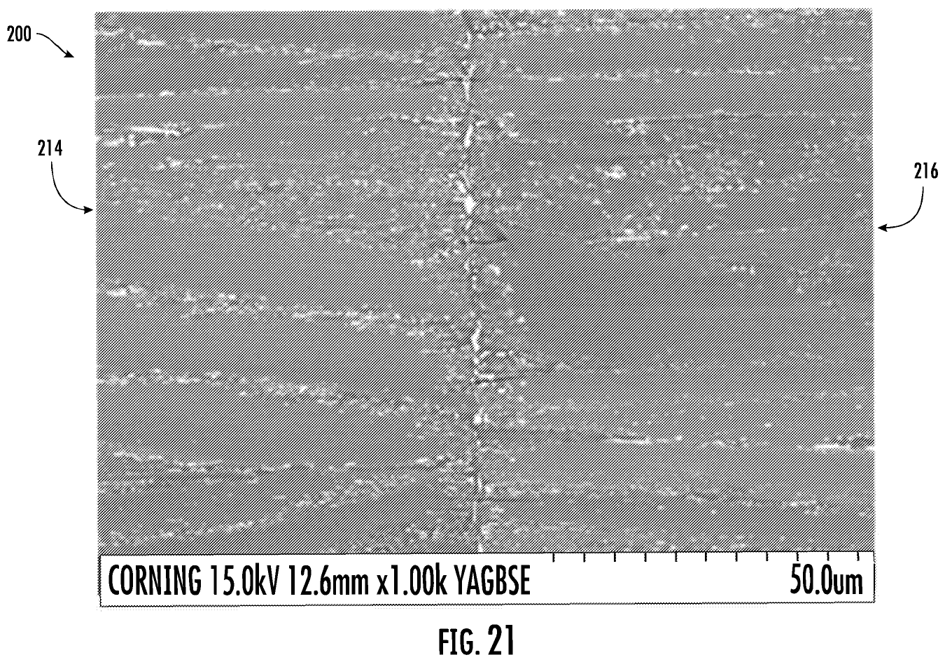

FIG. 19 depicts an SEM micrograph of a crystalline article 200 having a thickness of 1.00 mm in which the crystalline regions 214, 216 were produced by holding an amorphous glass at 1070° C. for 250 minutes. FIG. 20 depicts an SEM micrograph of a crystalline article 200 having a thickness of 1.03 mm in which the crystalline regions 214, 216 were produced by holding an amorphous glass at 1060° C. for 330 minutes. FIG. 21 depicts an SEM micrograph of a crystalline article 200 having a thickness of 1.17 mm in which the crystalline regions 214, 216 were produced by holding an amorphous glass at 1070° C. for 300 minutes. The crystalline articles 200 of FIGS. 19-21 were prepared from the same glass composition as the crystalline article 200 of FIG. 17. As can be seen from FIGS. 17-21, the crystalline phase of the crystalline article changes as the thickness of the glass-ceramic article increases.

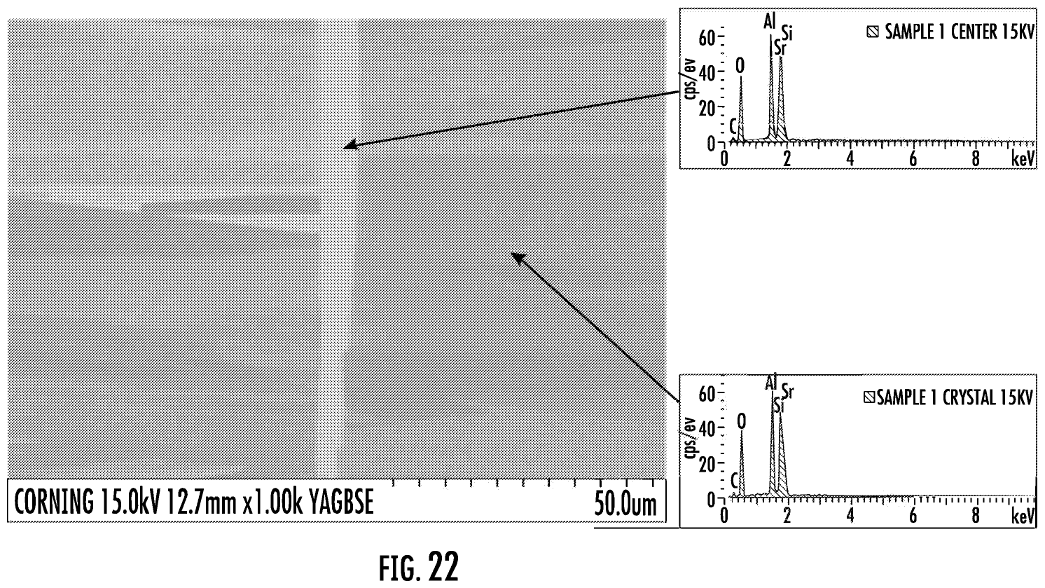

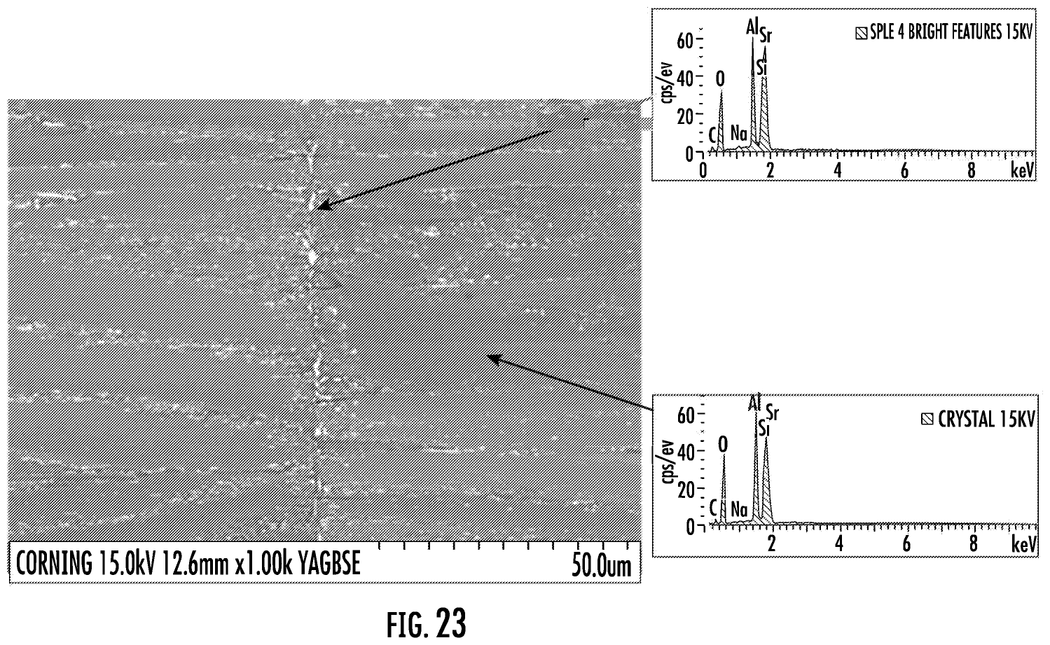

In particular, crystalline glass-ceramic article of FIG. 18 includes a single structure of crystalline material (gray areas in the SEM micrograph), whereas the crystalline articles of FIGS. 19-21 include at least two structures of crystalline material (gray areas and white areas in the SEM micrographs). As shown in FIGS. 22 and 23, energy dispersive spectroscopy (EDS) was performed on the crystalline samples of FIGS. 18 and 21 to determine characteristics of each crystalline structure.

FIG. 22 shows that the gray areas within the SEM micrograph of the 0.53 mm sample have substantially the same elemental composition. That is, the peaks for the various detected elements (O, Al, Si, Sr) have substantially the same level of intensity, indicating that the crystals have substantially the same composition. In contrast, FIG. 23 shows that the level of Sr is enriched in the white phases relative to the amount of Sr present in the gray phases. Accordingly, the amount of Sr in the white phase is greater than the amount of Sr in the gray phase.

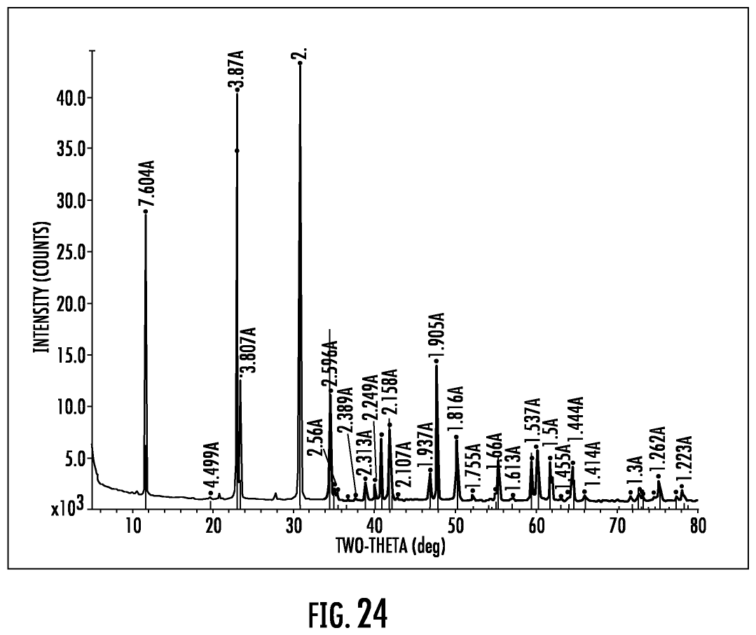

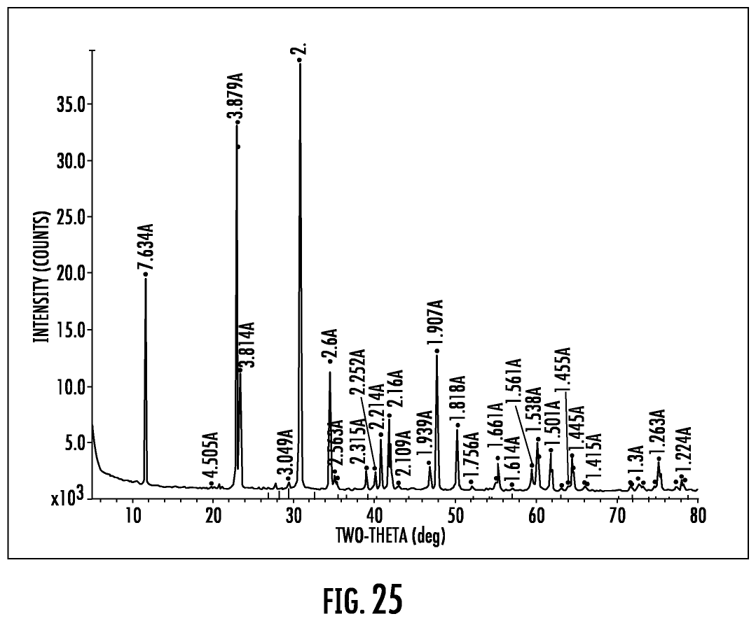

To determine the actual composition of each phase. Powderx-ray diffraction (XRD) was performed on fully crystalline samples produced from the 149AHI composition heat treated for the same amount of time, 4 hours and 34 minutes. One sample had a thickness of 0.52 mm, and the other sample had a thickness of 1.07 mm. FIG. 24 depicts the XRD spectra for the sample having a thickness of 0.52 mm. As can be seen in FIG. 24, the peaks of the spectra are consistent with a single crystalline phase of Sr(Al₂Si₂O₈) (as denoted vertical lines extending from the x-axis). FIG. 25 depicts the XRD spectra for the sample having a thickness of 1.07 mm. As can be seen in FIG. 25, the peaks of the spectra correspond not only to the crystalline phase of Sr(Al₂Si₂O₈) but also to the crystalline phase of SrSiO₃ (as denoted by the vertical lines extending from the x-axis). Thus, using the same composition and heat treatment, crystalline articles having different crystalline phases present were produced, leading the Applicant to conclude that the difference in thickness was primarily responsible for the development of the secondary phase.

Using image analysis, the amount of the second phase (SrSiO₃) present in each of the crystalline glass-ceramics of FIGS. 19-21 was determined and is provided in Table 2.

TABLE 2
Amount of Second Crystal Phase based on Sample Thickness

| Sample Thickness | Percent Area of Second Phase |
|---|---|
| 1.00 mm | 4.74% |
| 1.03 mm | 7.42% |
| 1.17 mm | 8.44% |

As can be seen from Table 2, the amount of the second crystalline phase increases as the thickness of the crystalline article increases. In that the second phase was not present in the crystalline article of FIG. 18, the Applicant surmises, without wishing to be bound by theory, that the formation of the second phase can be suppressed based on the thickness of the crystalline article. In particular, it is hypothesized that the crystal formation pushes out unconsumed elements into the remaining glass phase as the crystals grow, eventually leading to an enriched composition that is prone to crystallization of a new phase. Thicker crystalline articles start with a larger amorphous section to be enriched by unconsumed elements, thereby more readily creating a condition in which a second phase can form.

Accordingly, in one or more embodiments, the thickness T of the crystalline article 200 is 1 mm or less, in particular 0.95 mm or less, 0.9 mm or less, 0.85 mm or less, 0.8 mm or less, 0.75 mm or less, 0.7 mm or less, 0.65 mm or less, 0.6 mm or less, 0.55 mm or less, 0.5 mm or less, 0.45 mm or less, 0.4 mm or less, 0.35 mm or less, 0.3 mm or less, 0.25 mm or less, 0.2 mm or less, 0.15 mm or less, 0.1 mm or less. In one or more embodiments, the thickness T of the crystalline article 200 is 0.05 mm or more, 0.1 mm or more, 0.15 mm or more, 0.2 mm or more, 0.25 mm or more, 0.3 mm or more, 0.35 mm or more, 0.4 mm or more, 0.45 mm or more, or 0.5 mm or more. In one or more embodiments, the thickness T of the crystalline article 200 is in a range from 0.05 mm to 1 mm, 0.1 mm to 1 mm, 0.15 mm to 1 mm, 0.2 mm to 1 mm, 0.25 mm to 1 mm, 0.3 mm to 1 mm, 0.35 mm to 1 mm, 0.4 mm to 1 mm, 0.45 mm to 1 mm, or 0.5 mm to 1 mm.

In one or more embodiments, the crystalline article 200 comprises at least 90 vol % of a single crystalline phase (in particular having the structure of Sr(Al₂Si₂O₈)), at least 91 vol % of the single crystalline phase, at least 92 vol % of the single crystalline phase, at least 93 vol % of the single crystalline phase, at least 94 vol % of the single crystalline phase, at least 95 vol % of the single crystalline phase, at least 96 vol % of the single crystalline phase, at least 97 vol % of the single crystalline phase, at least 98 vol % of the single crystalline phase, or at least 99 vol % of the single crystalline phase. In one or more embodiments, the crystalline article 200 comprises no more than 10 vol % of a second crystalline phase (in particular having the structure of SrSiO₃), no more than 9 vol % of the second crystalline phase, no more than 8 vol % of the second crystalline phase, no more than 7 vol % of the second crystalline phase, no more than 6 vol % of the second crystalline phase, no more than 5 vol % of the second crystalline phase, no more than 4 vol % of the second crystalline phase, no more than 3 vol % of the second crystalline phase, no more than 2 vol % of the second crystalline phase, or no more than 1 vol % of the second crystalline phase.

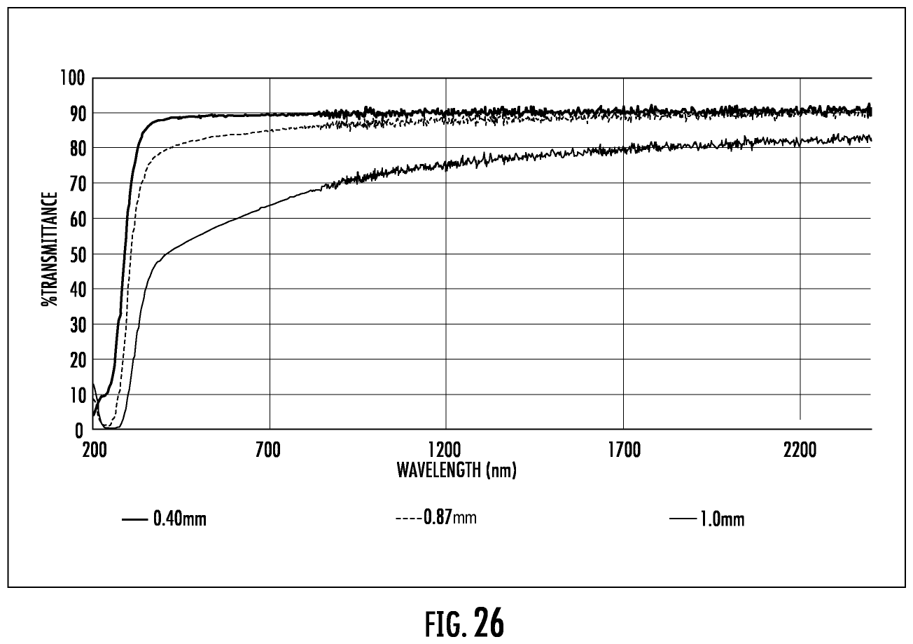

Providing a crystalline article 200 having a single phase of crystalline material, in particular columnar crystals of such material, enhances transmittance of light in the visible spectrum through the crystalline article 200. FIG. 26 depicts transmittance through crystalline articles 200 for articles having thicknesses of 0.40 mm, 0.87 mm, and 1.0 mm. The crystalline articles 200 were formed from the 149AHI composition. The 0.40 mm sample was heat treated at 1070° C. for 2 hours and 13 minutes. The 0.87 mm sample was heat treated at 1070° C. for 4 hours and 10 minutes, and the 1.0 mm sample was heat treated at 1070° C. for 5 hours. Each of the samples was fully crystalline (i.e., the surface nucleated crystalline regions 214, 216 met at approximately the midline of each sample). As can be seen in FIG. 26, the transmittance in the visible spectrum for the samples less than 1 mm in thickness is over 70%. Indeed, the transmittance is about 80% or more in the visible spectrum for the samples having a thickness of 0.40 mm and 0.87 mm, and the transmittance approaches 90% for the 0.40 mm thick sample. In contrast, the sample having a thickness of 1 mm had a drastically lower transmittance in the visible spectrum of under 60 percent for much of the visible spectrum and under 70% for the entire visible spectrum. Again, while transmittance is expected to drop somewhat as thickness of a sample increases, it is believed that the drastic decrease in transmittance relates to the formation of the secondary crystalline phase, which is more abundantly present in thicker samples.

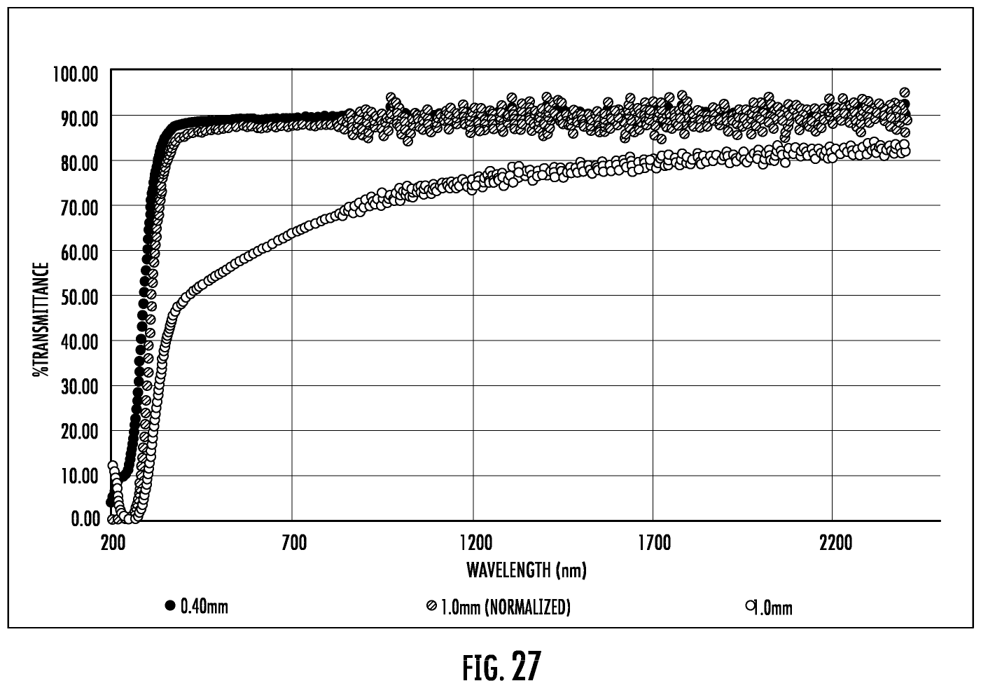

FIG. 27 supports the conclusion that the presence of the secondary crystal phase leads to a decrease in transmittance. FIG. 27 depicts transmittance for the 0.40 mm thick sample, which contains a single crystal phase (i.e., Sr(Al₂Si₂O₈), and as discussed, the transmittance approaches 90% for most, if not all, of the visible spectrum. The curve immediately beneath the 0.40 mm thick sample represents the calculated transmittance for a 1.0 mm (normalized) sample comprising only a single phase crystal of Sr(Al₂Si₂O₈). As can be seen, the transmittance decreases very little as a function of thickness where the structure remains a single phase of crystal. However, the next lower curve depicts transmittance of an actual 1.0 mm sample produced from the same composition as the 0.40 mm thick sample, which contained secondary crystal phases. From this curve, it can be seen that the transmittance is drastically reduced, which Applicant attributes to the presence of the secondary crystal phases.

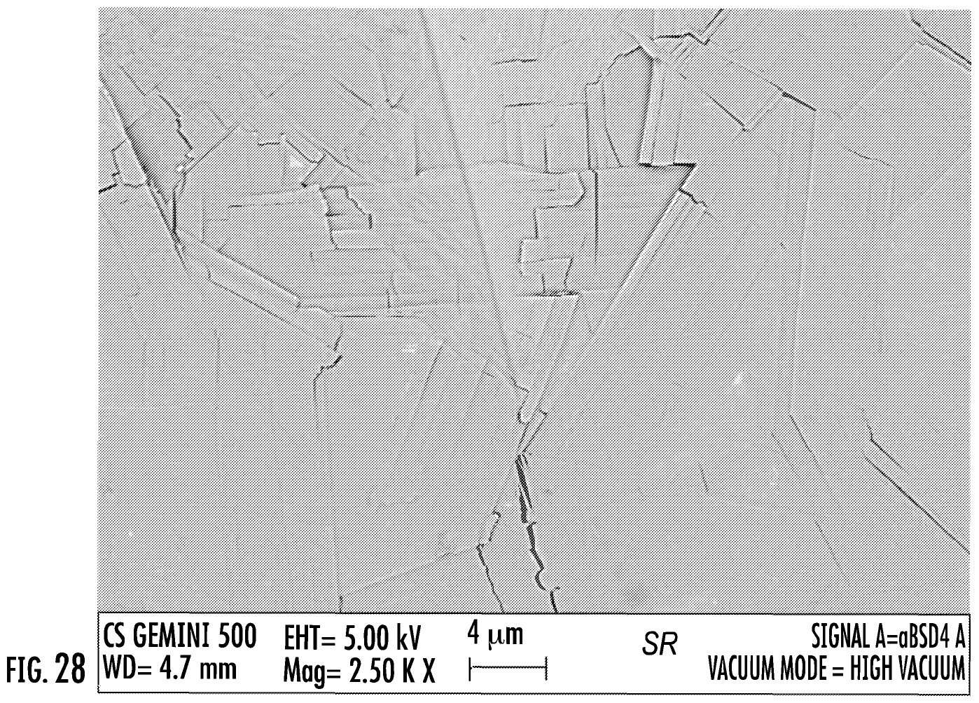

To test the crack resistance of the crystalline article, a Vickers hardness test was performed during which an indentation is made on the surface of the crystalline article from which the hardness and crack resistance of the crystalline article can be determined. Consistent with the findings above, it was found that the columnar crystals enhance crack resistance by creating a tortuous path for propagation of the crack. FIG. 28 shows a Vickers indentation on a crystalline article of the 149AHI composition. Prior to indentation, the surface was polished to remove 100 micrometers from the surface, eliminating any surface texture created during heat treatment. The crystalline article in the exemplary embodiment discussed in this paragraph was approximately 0.4 mm thick. Thereafter, the Vickers indenter was loaded at 1 kgf to cause crack formation in the crystalline article. As shown in FIG. 28, the cracks follow a tortuous path, created, at least in part, by the columnar crystal growth extending from the surface of the crystalline article.

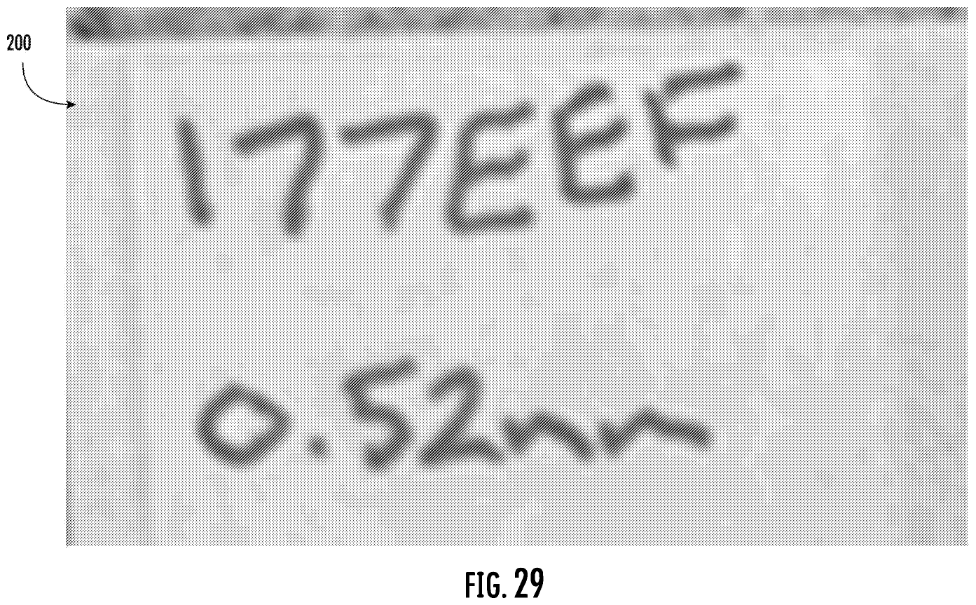

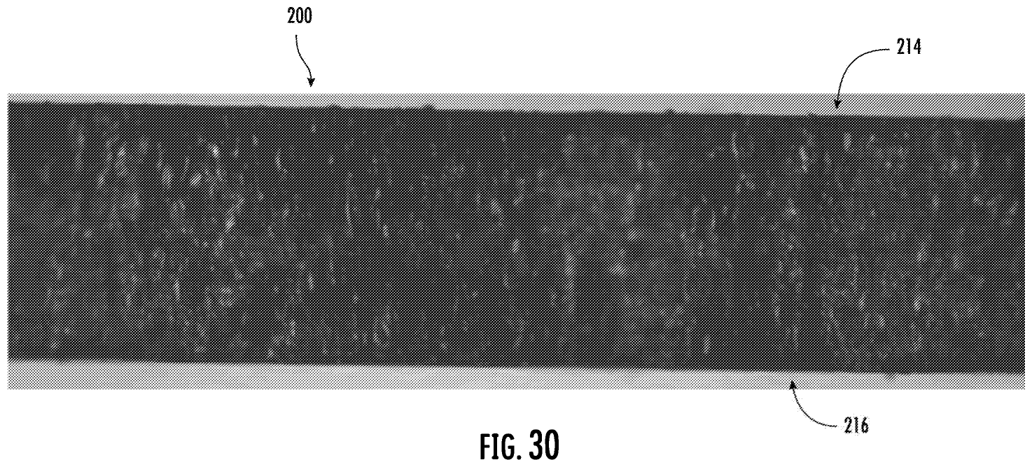

FIGS. 29 and 30 depict another embodiment of a crystalline article 200. The crystalline article was formed from a glass composition nominally including 40 mol % SiO₂, 32.5 mol % Al₂O₃, and 27.5 mol % SrO (the “177EEF composition”), and the glass composition was cast at a thickness of 0.52 mm. The glass composition was held at 1070° C. to nucleate crystal formations, and the glass composition was held at that temperature for 2 hours and 52 minutes, which resulted in a fully crystalline article as shown in FIG. 30. While the columnar crystal formation is apparent from FIG. 30, the interface between the first and second crystalline regions at the midpoint of the thickness is not as apparent as in other samples (e.g., as compared to the fully crystalline sample of FIG. 8). As can be seen in FIG. 29, the crystalline article 200 formed of the 177EEF composition is substantially transparent (i.e., the writing underlying the crystalline article 200 is clear and visible).

In experimenting with different compositions, the Applicant found that compositions containing 40 mol % to 50 mol % of silica and alumina that is equal to or more than strontium oxide up to a maximum of 5 mol % maintained both favorable mechanical properties and reasonable transparency. Samples that contained excess strontium oxide in relation to alumina tended to produce more secondary phase (SrSiO₃), leading to lower transparency and diminished mechanical reliability. Thus, in one or more embodiments, the strontium oxide is maintained less than alumina. However, significant excess alumina in relation to strontium oxide also produced poor optical clarity and poor mechanical reliability. Thus, in one or more embodiments, the alumina is no more than 5 mol % greater than strontium oxide.

Construction and arrangements of the compositions, assemblies, and structures, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations) without materially departing from the novel teachings and advantages of the subject matter described herein. Materials disclosed herein may be useful for purposes other than acting as cover glass or window glass, such as for household items, decorations, dishware, optical technologies, etc. The order or sequence of any process, logical algorithm, or method steps may be varied or re-sequenced according to alternative embodiments and/or aspects. Other substitutions, modifications, changes, and omissions may also be made in the design, operating conditions, and arrangement of the aspects in this disclosure without departing from the scope of the present inventive technology.

1-30. (canceled)

31. A crystalline article, comprising in terms of mole percent (mol %) of constituent oxides:
40 mol %≤SiO₂≤50 mol %;
25 mol %≤Al₂O₃≤32.5 mol %; and
22.5 mol %≤SrO≤30 mol %;
wherein Al₂O₃≥SrO; and
wherein the crystalline article comprises at least 90 volume percent (vol %) crystalline material; and
wherein the crystalline material comprises at least 90 vol % of a single phase of crystal.

32. The crystalline article of claim 31, wherein the crystalline article comprises a first major surface and a second major surface, the second major surface being opposite to the first major surface, and wherein a distance between the first major surface and the second major surface defines a thickness of the crystalline article, the thickness being at most 1 mm.

33. The crystalline article of claim 32, wherein the crystalline article comprises columnar crystals, wherein most of the columnar crystals are oriented within 15 degrees of normal to one or both of the first major surface and the second major surface of the crystalline article.

34. The crystalline article of claim 31, wherein the single phase of crystal is Sr(Al₂Si₂O₈).

35. The crystalline article of claim 31, wherein the crystalline phase comprises 1 vol % or less of a second phase of crystal.

36. The crystalline article of claim 31, wherein the second phase is SrSiO₃.

37. The crystalline article of claim 31, wherein the crystalline article transmits at least 70% of light having a wavelength of 400 nm to 800 nm.

38. The crystalline article of claim 31, wherein 0<Al₂O₃—SrO≤5 mol %.

39. The crystalline article of claim 32, wherein the crystalline article comprises a first crystalline region extending from the first major surface into the thickness and a second crystalline region extending from the second major surface into the thickness, and wherein the first crystalline region meets the second crystalline region at about a midpoint of the thickness.

40. The crystalline article of claim 31, comprising 1 mol % or less of other constituents individually and 5 mol % or less of all the other constituents in total.

41. A crystalline article, comprising:
40 mol % to 50 mol % SiO₂;
Al₂O₃; and
SrO;
wherein 0<Al₂O₃—SrO≤5 mol %;
wherein the crystalline article comprises a first major surface, a second major surface, and a thickness, the second major surface being opposite to the first major surface and the thickness being a distance between the first major surface and the second major surface; and wherein the thickness is 1 mm or less.

42. The crystalline article of claim 41, wherein SiO₂+Al₂O₃+SrO≥85 mol %.

43. The crystalline article of claim 41, wherein the crystalline article comprises at least 90 vol % of crystalline phase.

44. The crystalline article of claim 43, wherein the crystalline phase comprises at least 90 vol % of a first crystal structure.

45. The crystalline article of claim 44, wherein the first crystal structure is Sr(Al₂Si₂O₈).

46. The crystalline article of claim 44, wherein the crystalline phase comprises no more than 1 vol % of a second crystal structure.

47. The crystalline article of claim 46, wherein the second crystal structure is SrSiO₃.

48. The crystalline article of claim 41, further comprising a first crystalline region and a second crystalline region, wherein the first crystalline region comprises columnar crystals extending from the first major surface toward a midpoint of the thickness and wherein the second crystalline region comprises columnar crystals extending from the second major surface toward the midpoint of the thickness.

49. The crystalline article of claim 48, wherein the columnar crystals are oriented within 15° of normal to the respective first major surface and the second major surface.

50. The crystalline article of claim 41, wherein at least 70% of light having a wavelength in a range from 400 nm to 800 nm that is incident upon one of the first major surface or the second major surface of the crystalline article is transmitted through the crystalline article to the other of the first major surface or the second major surface.

50-60. (canceled)
